(19) United States
(12) Patent Application Publication
(10) Pub. No.: US 2024/0322422 A1
(43) Pub. Date: Sep. 26, 2024

(54) ANTENNA DEVICE

(71) Applicant: YOKOWO CO., LTD., Tokyo (JP)

(72) Inventor: Bunpei HARA, Tomioka-Shi, Gunma (JP)

(73) Assignee: YOKOWO CO., LTD., Tokyo (JP)

(21) Appl. No.: 18/578,730

(22) PCT Filed: Jul. 15, 2022
(86) PCT No.: PCT/JP2022/027923

§ 371 Date: Jan. 12, 2024

Related U.S. Application Data
(60) Provisional application No. 63/223,366, filed on Jul. 19, 2021.

(51) Int. Cl. H01Q 1/32; G01S 7/03; G01S 13/931; H01Q 1/52; H01Q 15/18

(52) U.S. Cl. CPC H01Q 1/32; G01S 7/03; G01S 13/931; H01Q 1/52; H01Q 15/18

(57) ABSTRACT

An antenna device disposed at a mobile body that includes a structural portion, the antenna device includes: an antenna element disposed apart from the structural portion, the antenna element supporting radio waves in a predetermined frequency band; and a reflective element configured to reflect the radio waves, the reflective element being located between the structural portion and the antenna element in a radiation direction of the radio waves.

### TECHNICAL FIELD

The present disclosure relates at an antenna device.

### BACKGROUND ART

Patent Literature 1 describes an antenna disposed to a side mirror of a vehicle.

### CITATION LIST

### Patent Literature

[PTL 1] Japanese Patent Application Publication No. H11-42977

### SUMMARY OF INVENTION

### Technical Problem

In the antenna described in Patent Literature 1, the directivity may deteriorate due to the influence of the radio wave scattering in a vehicle body. Such deterioration of directivity also occurs at an antenna disposed where other than the vehicle body.

An example of an object of the present disclosure is to suppress deterioration of directivity of an antenna caused by radio wave scattering. Other objects of the present disclosure will become apparent from the present specification given herein.

### Solution to Problem

An aspect of the present disclosure is an antenna device disposed at a mobile body that includes a structural portion, the antenna device comprising: an antenna element disposed apart from the structural portion, the antenna element supporting radio waves in a predetermined frequency band; and a reflective element configured to reflect the radio waves, the reflective element being located between the structural portion and the antenna element in a radiation direction of the radio waves.

According to an aspect described above of the present disclosure, it is possible to suppress deterioration of directivity of an antenna caused by radio wave scattering.

### BRIEF DESCRIPTION OF DRAWINGS

FIG. 1 is a plan view of a mobile body 1 at which an antenna device 10 is disposed.

FIG. 2A is a perspective view of a mobile body 1 at which an antenna device 10 is disposed.

FIG. 2B is an enlarged perspective view of an antenna device 10 and its surroundings in a mobile body 1.

FIG. 3A is a front view of an antenna 11.

FIG. 3B is a rear view of an antenna 11.

FIG. 4A is a top view of an antenna device 10.

FIG. 4B is a front view of an antenna device 10.

FIG. 4C is a rear view of an antenna device 10.

FIG. 4D is a side view of an antenna device 10.

FIG. 5A is a diagram illustrating the radiation pattern of an antenna 11 at an elevation angle E=0°.

FIG. 5B is a diagram illustrating the radiation pattern of an antenna 11 at an elevation angle E=−6°.

FIG. 5C is a diagram illustrating the radiation pattern of an antenna 11 at an elevation angle E=−3°.

FIG. 5D is a diagram illustrating the radiation pattern of an antenna 11 at an elevation angle E=3°.

FIG. 5E is a diagram illustrating the radiation pattern of an antenna 11 at an elevation angle E=6°.

FIG. 5F is a diagram illustrating the radiation pattern of an antenna 11 at an elevation angle E=10°.

FIG. 6 is an enlarged perspective view of an antenna device 10A and its surroundings in a mobile body 1.

FIG. 7A is a diagram illustrating the radiation pattern of an antenna 11A at an elevation angle E=0°.

FIG. 7B is a diagram illustrating the radiation pattern of an antenna 11A at an elevation angle E=−6°.

FIG. 7C is a diagram illustrating the radiation pattern of an antenna 11A at an elevation angle E=−3°.

FIG. 7D is a diagram illustrating the radiation pattern of an antenna 11A at an elevation angle E=3°.

FIG. 7E is a diagram illustrating the radiation pattern of an antenna 11A at an elevation angle E=6°.

FIG. 7F is a diagram illustrating the radiation pattern of an antenna 11A at an elevation angle E=10°.

FIG. 8 is a diagram illustrating the minimum gains of an antenna 11 and an antenna 11A.

FIG. 9A is a diagram illustrating the relationship between a distance DX in an antenna device 10 and the minimum gain of an antenna 11.

FIG. 9B is a diagram illustrating the relationship between a distance DY in an antenna device 10 and the minimum gain of an antenna 11.

FIG. 9C is a diagram illustrating the relationship between a length LZ of an antenna device 10 and the minimum gain of an antenna 11.

FIG. 10A is an explanatory diagram of an antenna device 10B including a compensator 30.

FIG. 10B is an explanatory diagram of an antenna device 10B in which the location of a compensator 30 is changed.

FIG. 11 is a block diagram illustrating a circuit of a compensator 30.

FIG. 12 is an enlarged perspective view of an antenna device 10C and its surroundings in a mobile body 1.

FIG. 13 is a diagram illustrating the radiation pattern of an antenna 11C at an elevation angle E=0°.

FIG. 14A is a perspective view of an antenna device 10D.

FIG. 14B is a perspective view of an antenna device 10E.

FIG. 15A is an enlarged perspective view of an antenna device 10F and its surroundings in a mobile body 1.

FIG. 15B is an enlarged perspective view of an antenna device 10G and its surroundings in a mobile body 1.

FIG. 16 is a diagram illustrating the minimum gains of an antenna 11, an antenna 11F, and an antenna 11G.

FIG. 17A is an enlarged perspective view of an antenna device 10H and its surroundings in a mobile body 1.

FIG. 17B is an enlarged perspective view of an antenna device 10I and its surroundings in a mobile body 1.

FIG. 17C is an enlarged perspective view of an antenna device 10J and its surroundings in a mobile body 1.

FIG. 17D is an enlarged perspective view of an antenna device 10K and its surroundings in a mobile body 1.

FIG. 18 is a diagram illustrating the minimum gains of an antenna 11 and an antenna 11H to an antenna 11K.

### DESCRIPTION OF EMBODIMENTS

At least following matters will become apparent from the present description and the accompanying drawings.

Hereinafter, preferred embodiments of the present disclosure will be described with reference to the drawings. The same or equivalent components, members, and the like illustrated in the drawings are given by the same reference numerals, and a description thereof is omitted as appropriate.

### ==Embodiments==

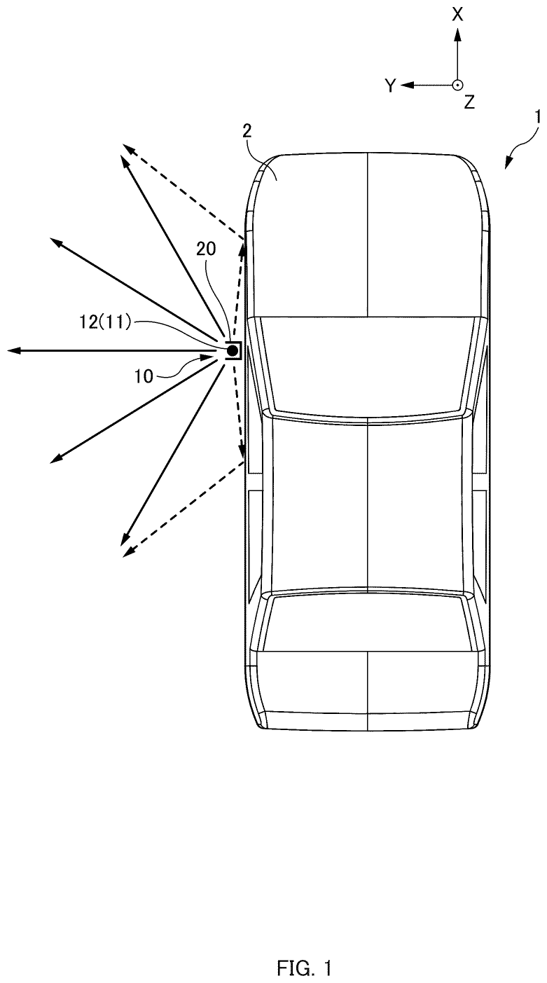

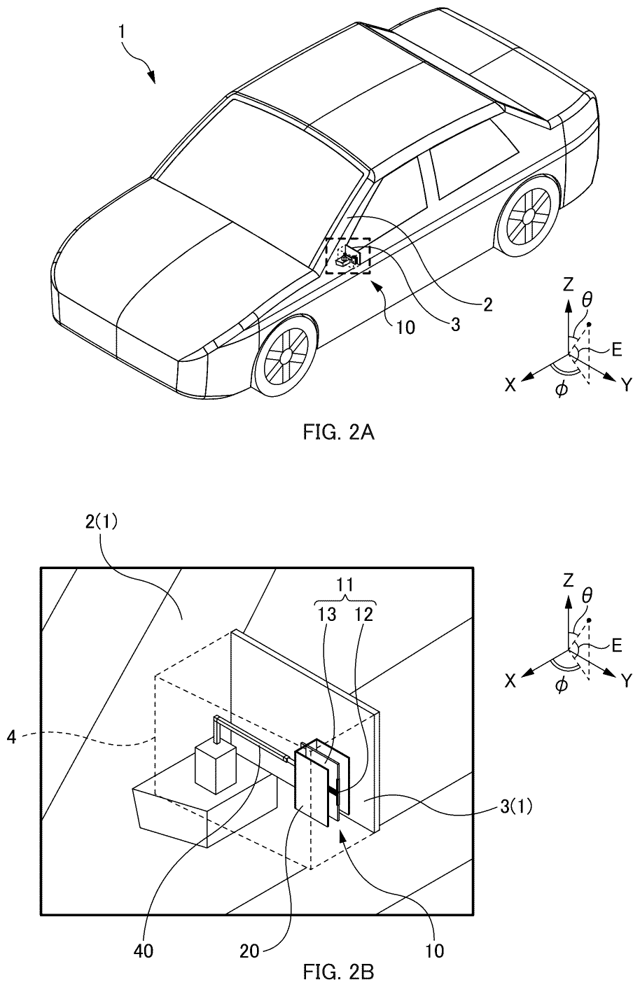

FIG. 1 is a plan view of a mobile body 1 at which an antenna device 10 is disposed. FIG. 2A is a perspective view of the mobile body 1 at which the antenna device 10 is disposed. FIG. 2B is an enlarged perspective view of the antenna device 10 and its surroundings in the mobile body 1.

### Definition of Directions and the Like

First, directions (X direction, Y direction, and Z direction) and the like in the antenna device 10 are defined, with reference to FIGS. 1, 2A, and 2B.

The forward direction seen from the driver's seat of the mobile body 1 (vehicle in an embodiment of the present disclosure) at which the antenna device 10 is disposed is defined as a +X direction (front direction) of the antenna device 10. Further, the left direction seen from the driver's seat of the mobile body 1 is defined as a +Y direction (left direction) of the antenna device 10, and the upward direction (zenith direction) seen from the driver's seat of the mobile body 1 is defined as a +Z direction (upward direction) of the antenna device 10. Directions opposite to the +X direction, +Y direction, and +Z direction are respectively defined as −X direction (backward direction), −Y direction (rightward direction), and −Z direction (downward direction). The +X direction, −X direction, +Y direction, −Y direction, +Z direction, and −Z direction are directions with fixed orientations.

When a direction is not a fixed direction as mentioned above, but indicates both the +X direction (front direction) and −X direction (backward direction), the direction may be simply referred to as the “X direction” or a “front-rear direction”. Similarly, when a direction indicates both the +Y direction (leftward direction) and −Y direction (rightward direction), the direction may be simply referred to as the “Y direction” or a “left-right direction”.

Further, when a direction indicates both the +Z direction (upward direction) and the −Z direction (downward direction), the direction may be simply referred to as the “Z direction” or an “up-down direction”.

In FIGS. 1, 2A, and 2B, in order to facilitate the understanding of the directions and the like of the antenna device 10, the +X direction (forward direction), +Y direction (leftward direction), and +Z direction (upward direction) are each given by a line segment with an arrow. The point of intersection between these arrowed line segments does not mean the coordinate origin. The front-rear direction or left-right direction may be referred to as “lateral direction” or a “width direction”, and the up-down direction may be referred to as “vertical direction” or a “height direction”.

The above-described definitions of directions and the like are also common to other embodiments in the present description unless otherwise specified.

### <<Overview of Antenna Device 10>>

Next, referring again to FIGS. 1, 2A, and 2B mentioned above, an overview of the antenna device 10 according to an embodiment of the present disclosure will be described.

The antenna device 10 is disposed at the mobile body 1. Here, the term “mobile body” refers to a vehicle or a vessel that moves. In an embodiment of the present disclosure, the mobile body 1 is a vehicle. Here, the term “vehicle” refers to a wheeled vehicle. Accordingly, in the following description, the “mobile body 1” may be referred to as “vehicle”. However, the mobile body 1 is not limited to the vehicle, and may be construction machinery, agricultural machinery, a vessel, a flight vehicle, a drone, and the like without wheels.

The mobile body 1 has a structural portion 2 and side mirrors 3, as illustrated in FIGS. 1 and 2A. In an embodiment of the present disclosure, the structural portion 2 is a housing portion that constitutes a space to accommodate a passenger, baggage, an engine, and the like in the vehicle. That is, the structural portion 2 is a vehicle body having a bonnet, a roof, pillars, a spoiler, a bumper, and the like. Accordingly, in the following description, the “structural portion 2” may be referred to as “vehicle body”. The side mirrors 3 are attached to the left and right sides of the vehicle body, respectively.

The antenna device 10 according to an embodiment of the present disclosure is disposed at the side mirror 3, as illustrated in FIG. 2A. In other words, the antenna device 10 is disposed so as to be apart from the vehicle body. However, the antenna device 10 may be disposed at a part of the vehicle other than the side mirror 3. For example, the antenna device 10 may be disposed so as to be apart from parts such as a windshield, the spoiler, and the bumper.

Further, when the mobile body 1 is one other than those such as the construction machinery and the agricultural machinery, the mobile body 1 may be disposed at a part appropriate for communication using the antenna such as a housing portion to house a prime mover such as an engine, a motor, or the like.

As illustrated in FIGS. 2A and 2B, the side mirror 3 protrudes in a direction away from the vicinity of a door portion of the vehicle body. The side mirrors 3 each include a mirror (not illustrated) that reflects the side and rear of the vehicle body, and a case 4.

The driver of the vehicle can check the sides and rear of the vehicle through the mirrors.

The side mirror 3 may be a so-called side mirror with camera or an electronic side mirror. Such a side mirror with camera and an electronic side mirror have a camera and an image display device.

As with the side mirror 3 illustrated in FIG. 2A, the camera protrudes in a direction away from the vicinity of the door portion of the vehicle body, and is disposed to image the side and rear of the vehicle body. Further, the image display device is connected to the above-mentioned camera, to thereby display an image captured by the camera. The image display device is, for example, a liquid crystal panel, and is disposed inside the vehicle. The side mirrors with cameras and electronic side mirrors allow a vehicle driver to check the sides and rear of the vehicle through images captured by the cameras.

In the following description, a device to check the surroundings of the mobile body 1, including the side mirror 3 illustrated in FIG. 2B, a side mirror with a camera, and an electronic side mirror, may be referred to as device to check surroundings.

The antenna device 10 comprises an antenna 11 and a reflective element 20, as illustrated in FIG. 2B.

The antenna 11 is an antenna for mobile communications, and is used for, for example, Vehicle to Everything (V2X: vehicle-to-vehicle communication, road-to-vehicle communication). The antenna 11 used for V2X supports radio waves in 5.9 GHz band, for example. The term “radio waves” may be referred to as “electromagnetic waves” in the following explanation. Further, the antenna 11 supports linearly polarized waves. The linearly polarized waves may also be referred to as, for example, vertically polarized waves when the polarization plane is vertical to the ground, and as horizontally polarized waves when the polarization plane is horizontal to the ground.

The communication standards and frequency bands supported by the antenna 11 are not limited to 5.9 GHz band used for V2X described above, and may be other communication standards and frequency bands. The antenna 11 may support radio waves in 2.4 GHz band and 5 GHz band used for Wi-Fi (registered trademark), Bluetooth (registered trademark), and the like. The antenna 11 may support radio waves in a frequency band of at least part of the frequency bands for telematics, GSM, UMTS, LTE, and 5G, for example.

The antenna 11 may also support multiple-input multiple-output (MIMO) communication. In the MIMO communication, data are transmitted from a plurality of antennas that are configured with the antennas 11, and are simultaneously received by a plurality of antennas. Further, the antenna 11 may be a keyless entry antenna or a smart entry antenna.

In an embodiment of the present disclosure, the antenna 11 is a dipole antenna. However, the antenna 11 may use the antenna format other than the dipole antenna, as long as the antenna format can support the linearly polarized radio waves. The antenna 11 may be, for example, a monopole antenna, a sleeve antenna, a collinear array antenna, a dipole array antenna, a slot array antenna, a Yagi antenna, a patch antenna, or the like.

The antenna 11 according to an embodiment of the present disclosure is a nondirectional antenna. However, due to the influence of the structural portion 2 (vehicle body) and the like of the vehicle, it may be difficult that the antenna 11 obtains a desired gain in a specific direction. Thus, as will be described later, the antenna 11 realizes the desired directivity, by changing the place where it is disposed, disposing a plurality of antennas 11 at the mobile body 1 to employ a diversity system.

The antenna device 10 employing the diversity system includes, for example, a plurality of (for example, two) antennas 11. Here, these two antennas 11 are disposed to the mobile body 1 at positions that are symmetrical (line symmetrical) to each other with respect to the axis along the X direction. In the diversity system, when signals are received by these two the antennas 11, the larger one is selected out of the received signals. Then, as the entire directivity of these two antennas 11, the directivity of the individual antennas 11 are superimposed, and only the maximum value of the gain is selected. This enables the antenna device 10 employing the diversity system to obtain the equivalent gains in all directions within the horizontal plane, to thereby achieve the desired directivity.

In an embodiment of the present disclosure, the antenna 11 is disposed at the side mirror 3 of the vehicle. The antenna 11 is disposed inside the case 4, made of resin, attached to the side mirror 3, as illustrated in FIG. 2B. When the antenna 11 is disposed to the side mirror 3, it is disposed as apart from the structural part 2 (vehicle body) of the vehicle as possible. This is because the structural part 2 of the vehicle shields radio waves, and thus if the antenna 11 is disposed close to the structural part 2 of the vehicle, the proportion of the radiation directions of the antenna 11 shielded by the structural part 2 of the vehicle results in being large.

Accordingly, with the antenna 11 being disposed as apart from the structural part 2 (vehicle body) of the vehicle as possible, it is possible to reduce the range in which the radio waves supported by the antenna 11 are shielded by the structural part 2, and increase the range of the directivity of the antenna 11. Accordingly, the antenna 11 according to an embodiment of the present disclosure is disposed at the end portion of the side mirror 3 on the side opposite to the structural part 2 (the side in the +Y direction). However, the antenna 11 may be disposed at the end portion of the side mirror 3 on the side of the structural portion 2 (the side in the −Y direction). Further, the antenna 11 may be disposed in the middle portion of the side mirror 3 in the lateral direction.

Further, in an embodiment of the present disclosure, the antenna 11 is disposed at the side mirror 3 on the left side of the vehicle. In the mobile body 1, at which the antenna device 10 is disposed, multiple antennas that support the radio waves of the frequency band used for V2X, including the antenna 11, may be disposed and these multiple antennas may be used in combination. In this case, the above-mentioned diversity system may be employed as the entire directivity of the antennas disposed in the mobile body 1.

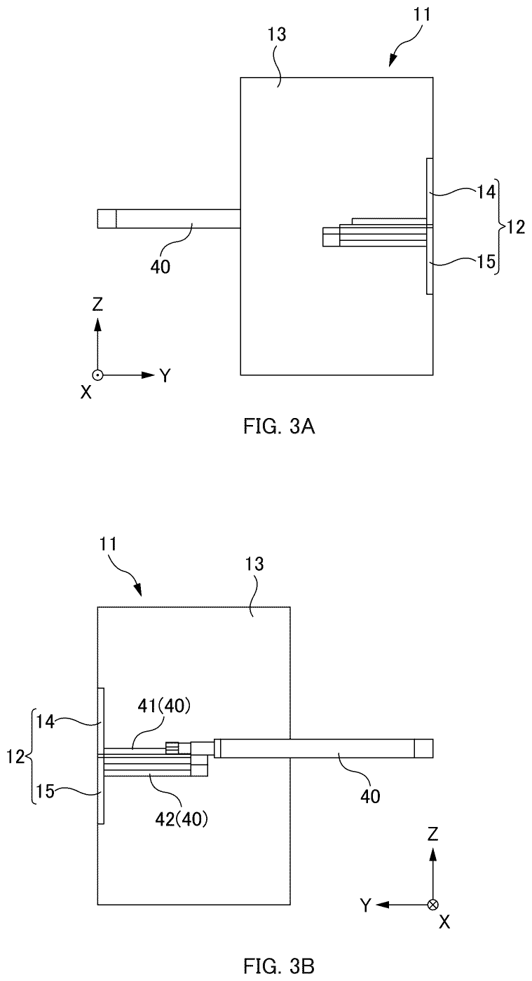

The coaxial cable 40 is connected to the antenna 11 as illustrated in FIG. 2B. The coaxial cable 40 is a feeder connected to the antenna 11. As illustrated in FIG. 3B which will be described later, the coaxial cable 40 includes a signal wire 41 that is an inner conductor and a ground wire 42 that is an outer conductor. Here, “connecting” is not limited to physical connecting but includes “electrical connecting”. Then, the “electrical connecting” includes, for example, connecting objects with a conductor, an electronic circuit, an electronic part, and/or the like.

Other explanations of the antenna 11 will be given later.

The reflective element 20 is a member to reflect the radio waves supported by the antenna 11. The reflective element 20 is, for example, at least partially formed of a conductor. The reflective element 20 may be formed of, for example, a sheet metal, a substrate where a conductive pattern is formed, a conductive film, or the like. Further, the reflective element 20 may be configured such that a conductive pattern is formed in a resin material using a molded interconnect device (MID) technique.

In the case of the radio waves in the frequency band (5.9 GHz band) used for V2X, the structural portion 2 of the mobile body 1 is significantly large relative to the wavelength of the radio waves, and thus the radio waves supported by the antenna 11 may be strongly affected by the scattering at the structural portion 2.

Here, what indicated by the sentence “the radio waves supported by the antenna 11 are affected by the scattering at the structural portion 2” will be explained as follows. For example, the length of the structural portion 2 of the mobile body 1 in the X direction is about 2500 to 4000 mm. The wavelength of 5.9 the GHz band, which is the frequency band used for V2X described above, is about 50 mm. Thus, when being converted into the wavelength of the radio wave frequency (5.9 GHz) supported by the antenna 11, the structural portion 2 corresponds to about 50 to 80 wavelengths. In other words, the structural portion 2 of the mobile body 1 according to an embodiment of the present disclosure is significantly large relative to the wavelength of the 5.9 GHz band.

The antenna 11 performs at least one of transmission or reception of radio waves in all directions. In general, if a conductive structure exists in the vicinity of the antenna, and the size of the structure is substantially one quarter or more of the wavelength, part of the electromagnetic waves emitted from the antenna excites currents on the surface of the structure, creating a new wave source. Then, radio waves are radiated (radio-wave radiation given by dashed lines in FIG. 1) by the new wave source, and radiation combining such radiation and the radiation from the antenna 11 (radio-wave radiation given by solid lines in FIG. 1) is emitted.

In this event, if the antenna device 10 does not have the reflective element 20, the radio waves in the direction toward the structural portion 2 as illustrated in FIG. 1 (radio waves given by the dashed lines in FIG. 1) are scattered at the structural portion 2. In this event, the radio waves (radio waves given by the solid lines in FIG. 1) directly radiated from the antenna 11 and the radio waves (radio waves given by the dashed lines in FIG. 1) scattered at the structural portion 2 interfere with each other, to thereby generate the radio waves in the direction in which the gains weaken each other and the direction in which the gains strengthen each other, when viewed from the antenna 11. In particular, as the distance between the antenna 11 and the structural portion 2 increases, the difference in path of interference increases and the gain deviation increases as well. In other words, when the antenna 11 is disposed apart from the structural portion 2 (vehicle body) of the mobile body 1 as illustrated in FIG. 1, the range of the directivity of the antenna 11 can be increased, but the gain deviation increases more. Accordingly, in the directivity of the antenna 11, a gain deviation occurs in a specific direction, and communication performance deteriorates. In other words, the directivity of the antenna 11 deteriorates. In an embodiment of the present disclosure, the radio waves in the frequency band used for V2X are described, but even the radio waves in the high frequency band other than those for V2X may be strongly affected by the scattering at the structural portion that is large relative to the wavelength, which may result in deterioration of the directivity of the antenna.

Here, in FIG. 1, the arrows (dashed arrows and solid arrows) extending from the antenna 11 indicate part of the radiation directions of the radio waves of the antenna 11 in a horizontal plane. The dashed arrows indicate the radiation directions toward the structural portion 2 of the mobile body 1 (the directions of the radio waves propagating to the structural portion 2), among the radiation directions. Further, the solid arrows indicate radiation directions other than the directions toward the structural portion 2 of the mobile body 1, among the radiation directions.

In an embodiment of the present disclosure, the reflective element 20 is located between the structural portion 2 of the mobile body 1 and the antenna element 12 (described later) of the antenna 11 in the radiation directions of the radio waves, as illustrated in FIG. 1. That is, the reflective element 20 is located between the structural portion 2 of the mobile body 1 and the antenna element 12 of the antenna 11 in the radiation directions given by the dashed arrows. That is, the reflective element 20 is disposed at a location at which the scattering of the radio waves by the structural portion 2 can be suppressed. This makes it possible to suppress the propagation of the radio waves to the structural portion 2, and suppress the gain deviation while having the directivity in the desired direction. In other words, it is possible to suppress the deterioration of the directivity of the antenna 11 caused by radio wave scattering.

Other descriptions of the reflective element 20 will be given later.

### <<Details of Antenna 11 and Reflective Element 20>>

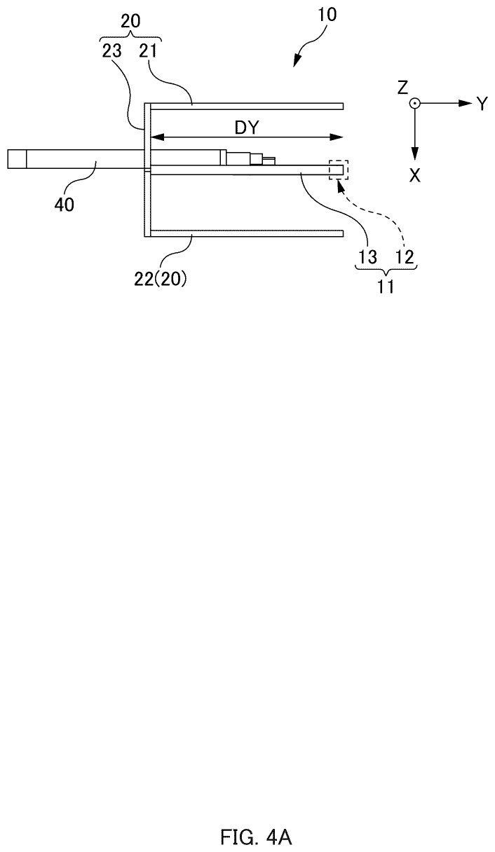

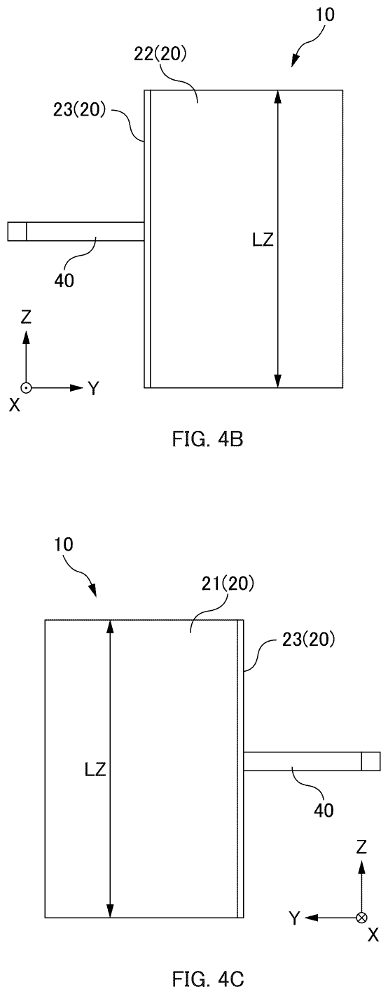

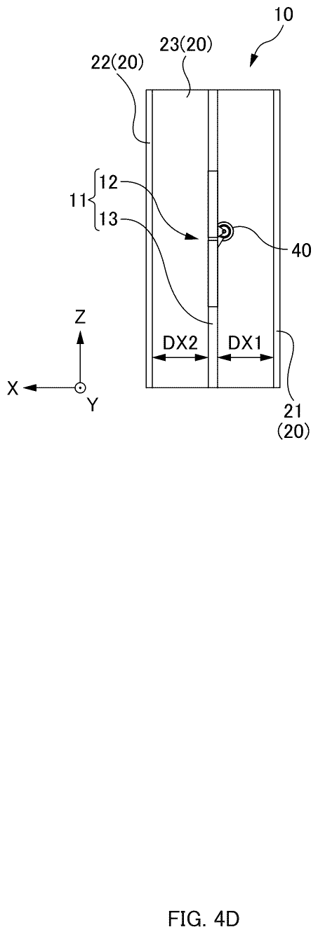

Next, the details of the antenna 11 and the reflective element 20 will be described with reference to FIGS. 3A, 3B, and FIGS. 4A to 4D.

FIG. 3A is a front view of the antenna 11. FIG. 3B is a rear view of the antenna 11. FIG. 4A is a top view of the antenna device 10. FIG. 4B is a front view of the antenna device 10. FIG. 4C is a rear view of the antenna device 10. FIG. 4D is a side view of the antenna device 10. FIGS. 3A and 3B omit the illustration of the reflective element 20 in the antenna device 10 illustrated in FIG. 2B, and illustrate only a portion corresponding to the antenna 11.

### <Antenna 11>

The antenna 11 includes an antenna element 12 and a substrate 13.

The antenna element 12 is an element used in the frequency band (here, 5.9 GHz band used for V2X) of the radio waves supported by the antenna 11. In an embodiment of the present disclosure, the antenna element 12 is formed at the substrate 13. However, the antenna element 12 may not be formed at the substrate 13, for example. Further, when the antenna element 12 is not formed at the substrate 13, the antenna 11 does not have to include the substrate 13. For example, the element 12 may be made of a sheet metal, a linear shaped metal, a conductive film, or the like.

The antenna element 12 includes a first element 14 and a second element 15, as illustrated in FIGS. 3A and 3B. The first element 14 is an element extending in the +Z direction, and the signal wire 41 of the coaxial cable 40 connected thereto. The second element 15 is an element extending in the −Z direction, and the ground wire 42 of the coaxial cable 40 is connected thereto. The antenna 11 is configured, as a dipole antenna, with the first element 14 and the second element 15. The first element 14 and the second element 15 of the antenna 11 each have a shape extending in the Z direction (linear shape, rod shape). However, the elements of the antenna 11 are not limited to a linear or rod shape, but may be formed into a polygonal shape such as a semicircular, circular, elliptical, or quadrilateral shape, or the like.

The substrate 13 is a plate-shaped member at which the antenna element 12 is formed. In an embodiment of the present disclosure, in the antenna 11, the substrate 13 is a printed circuit board (PCB). In addition, the substrate 13 is a rigid substrate, but is not limited thereto and may be a flexible substrate. In addition to the antenna element 12, circuit element(s) such as a filter and/or the like may be separately provided at the substrate 13.

### <Reflective Element 20>

The reflective element 20 includes a first reflective portion 21, a second reflective portion 22, and a third reflective portion 23, as illustrated in FIGS. 4A to 4D. In an embodiment of the present disclosure, the first reflective portion 21, the second reflective portion 22, and the third reflective portion 23 are coupled, as illustrated in FIG. 4A. This makes it possible to suppress the propagation of radio waves to the structural portion 2. Further, as illustrated in FIG. 2B, the first reflective portion 21, the second reflective portion 22, and the third reflective portion 23 are located such that they cover three sides on the structural portion 2 side (i.e., on the −X direction side, +X direction side, and −Y direction side) relative to the antenna element 12.

In an embodiment of the present disclosure, the first reflective portion 21, the second reflective portion 22, and the third reflective portion 23 are coupled, but they do not have to be coupled, for example, by having a gap therebetween. Further, part of the first reflective portion 21, the second reflective portion 22, and the third reflective portion 23 may be coupled.

The first reflective portion 21 is a member located on the −X direction side in the reflective element 20. The second reflective portion 22 is a member located on the +X direction side in the reflective element 20. The outer shape of each of the first reflective portion 21 and the second reflective portion 22 is substantially rectangular, as illustrated in FIGS. 4B and 4C. Here, the term “substantially rectangular” is included in the term “substantially quadrilateral”. Further, the term “substantially quadrilateral” means a shape consisting of four sides, for example, and at least part of corners thereof may be cut away obliquely relative to a side, for example. Alternatively, in the “substantially quadrilateral” shape, a recess (recessed portion) or a protrusion (protruding portion) may be provided to part of the sides. The outer shape of each of the first reflective portion 21 and the second reflective portion 22 may be a substantially quadrilateral shape other than a substantially rectangle shape, or may be a shape other than a substantially quadrilateral shape such as a semicircular, circular, elliptical, or polygonal shape.

Further, the outer shape of each of the first reflective portion 21 and the second reflective portion 22 may be a shape in which the center thereof bulges.

As illustrated in FIG. 4A, the first reflective portion 21 and the second reflective portion 22 are located so as to sandwich the antenna element 12 in the X direction. In other words, the antenna element 12 is located between the first reflective portion 21 and the second reflective portion 22 in the X direction. However, the first reflective portion 21 and the second reflective portion 22 may be located so as to sandwich the antenna element 12 in a direction (e.g., the Z direction) other than the X direction.

Furthermore, the first reflective portion 21 and the second reflective portion 22 do not have to be located so as to sandwich the antenna element 12.

The first reflective portion 21 and the second reflective portion 22 are disposed parallel to each other, as illustrated in FIG. 4A.

However, the first reflective portion 21 and the second reflective portion 22 do not have to be disposed parallel to each other. For example, the first reflective portion 21 and the second reflective portion 22 may be disposed such that they gradually open wider (the separation distance between the first the reflective portion 21 and the second the reflective portion 22 increases) toward the +Y direction, when the antenna device 10 is viewed in the direction in FIG. 4A. In contrast, the first reflective portion 21 and the second reflective portion 22 may be disposed such that they gradually close narrower (the separation distance between the first reflective portion 21 and the second reflective portion 22 decreases) toward the +Y direction. The directivity of the antenna 11 can be changed with the angle formed by the first reflective portion 21 and the second reflective portion 22.

The third reflective portion 23 is a member located on the −Y direction side in the reflective element 20. The third reflective portion 23 is located between the structural portion 2 of the mobile body 1 and the antenna element 12 in the Y direction. The outer shape of the third reflective portion 23 is a substantially rectangular shape, as illustrated in FIG. 4D. However, the outer shape of the third reflective portion 23 may be a substantially quadrilateral shape other than a substantially rectangle shape, or may be a shape other than a substantially quadrilateral shape such as a semicircular, circular, elliptical, or polygonal shape.

Further, the outer shape of the third reflective portion 23 may be a shape in which the center thereof bulges.

In the antenna device 10 according to an embodiment of the present disclosure, as illustrated in FIG. 4A, the coaxial cable 40 passes through the third reflective portion 23, thereby extending to the vehicle body side (−Y direction side). Thus, the third reflective portion 23 has an opening for the coaxial cable 40 to be inserted therethrough.

As described above, in an embodiment of the present disclosure, the first reflective portion 21, the second reflective portion 22, and the third reflective portion 23 are coupled, and located such that they cover three sides on the structural portion 2 side with respect to the antenna element 12. However, an aspect of the reflective element 20 is not limited thereto. The reflective element 20 may include only one of the first reflective portion 21, the second reflective portion 22, and the third reflective portion 23. The reflective element 20 may include only any two of the first reflective portion 21, the second reflective portion 22, and the third reflective portion 23. That is, the reflective element 20 only have to have an aspect in which it is located between the mobile body 1 and the antenna element 12 of the antenna 11 in the radiation direction of radio waves.

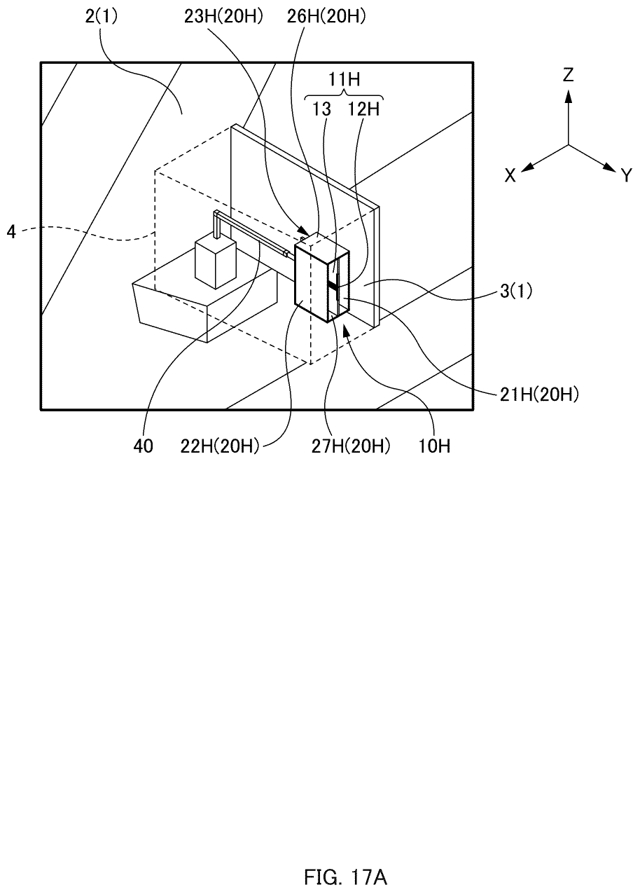

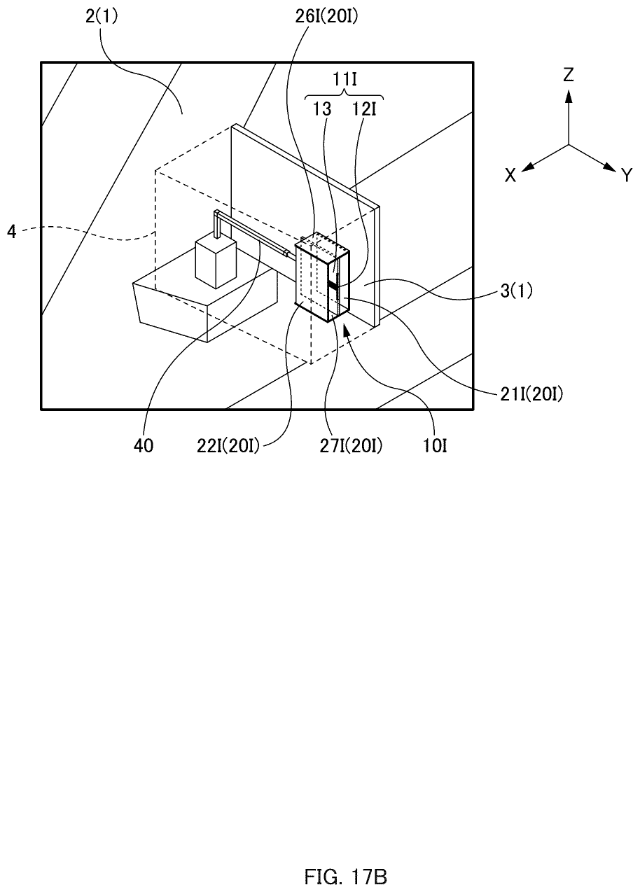

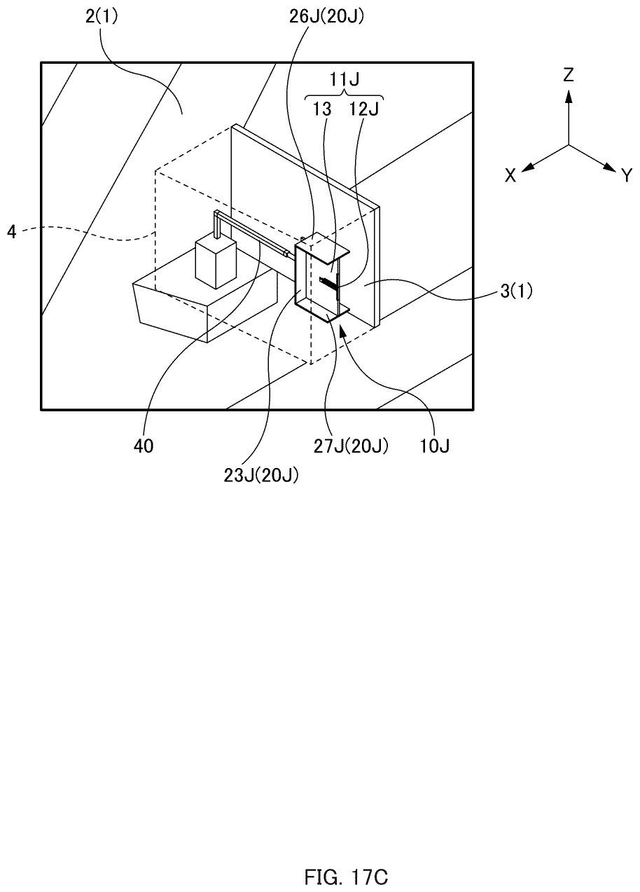

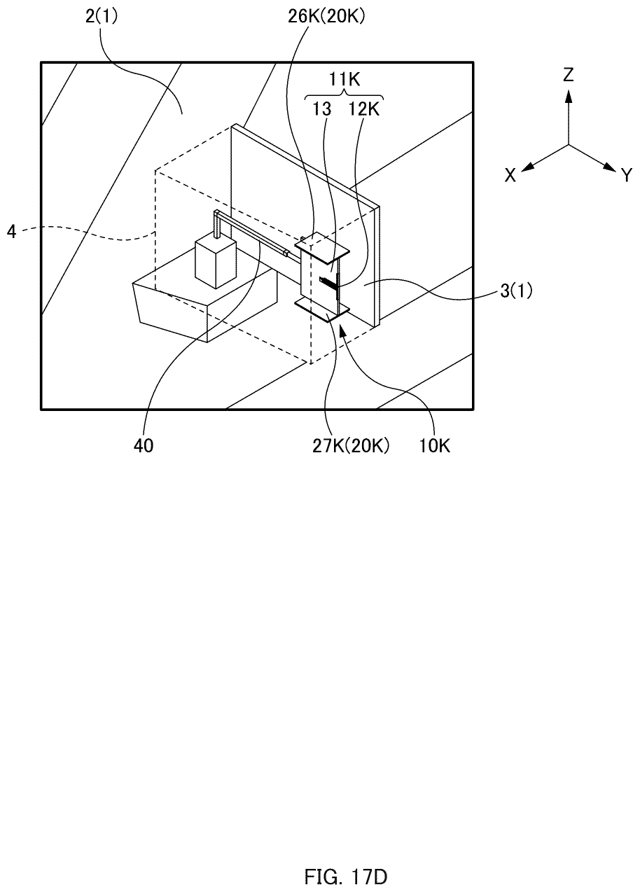

With the reflective element 20 being located on the extension of the desired range of radiation angle when viewed from the antenna 11 (i.e., located between the mobile body 1 and the structural portion 2 in the radiation direction of radio waves), the effect of mitigating the influence of the mobile body 1 in the desired range of angle increases. In an embodiment of the present disclosure, the first reflective portion 21 and the second reflective portion 22 are disposed in front of and on the rear side of the antenna element 12, respectively, in order to achieve the effect of widening the range of the angle in the front-rear direction, in the range on the left side of the mobile body 1, as will be described later. In addition, for example, as in FIGS. 17A to 17D described later, the addition of the reflective elements in the up-down direction of the antenna element 12 has an effect of mitigating the influence of the mobile body 1 also in the range of the angle in the up-down direction of the mobile body 1.

Further, as illustrated in FIG. 4A, the reflective element 20 has a substantially U-shape when viewed in the −Y direction, but it may also have a V-shape, a Y-shape, an X-shape, or the like, for example.

Note that “DY” given in FIG. 4A, “LZ” given in FIGS. 4B and 4C, and “DX1” and “DX2” given in FIG. 4D will be described later.

### <<Characteristics of Antenna Device 10 Comprising Reflective Element 20>>

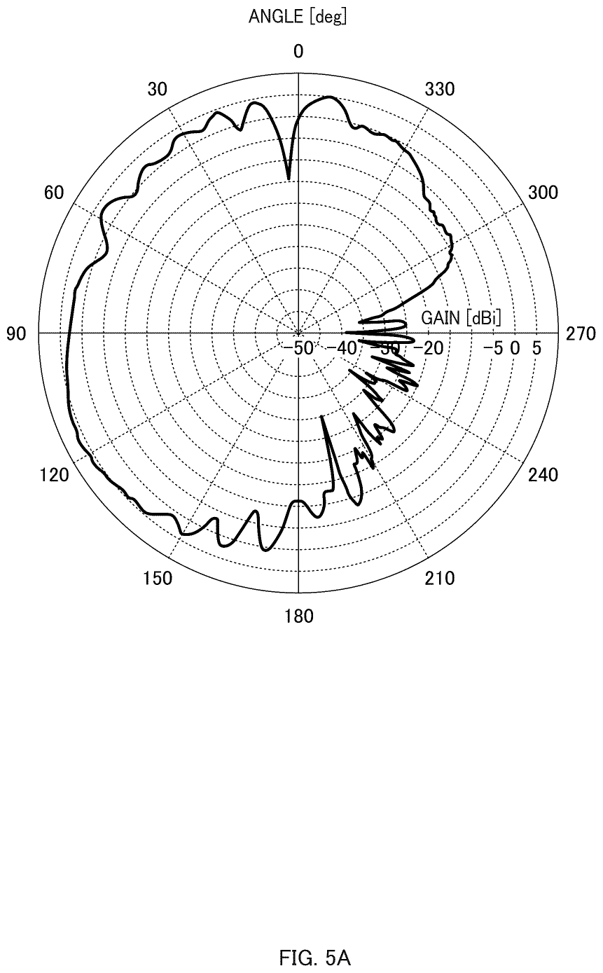

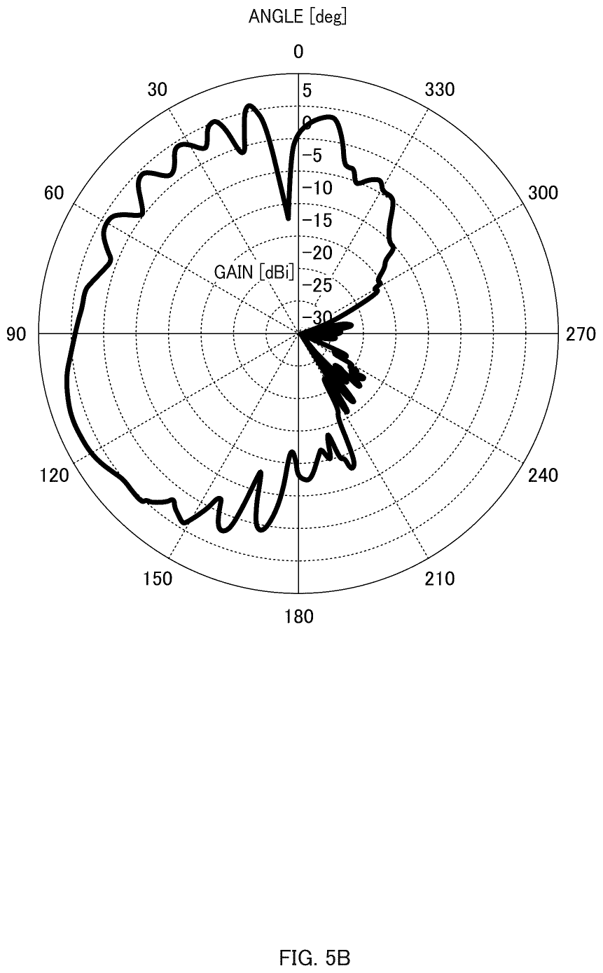

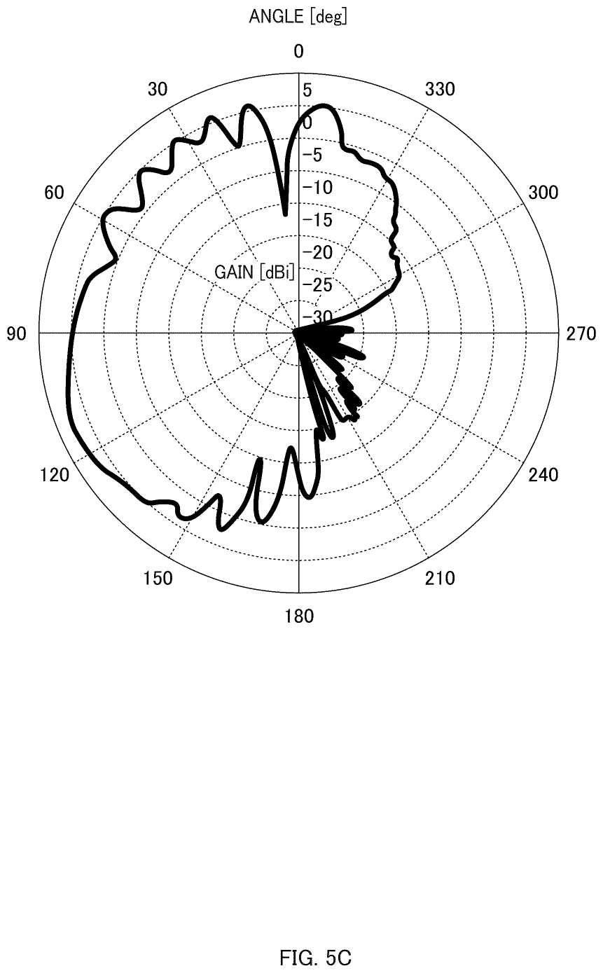

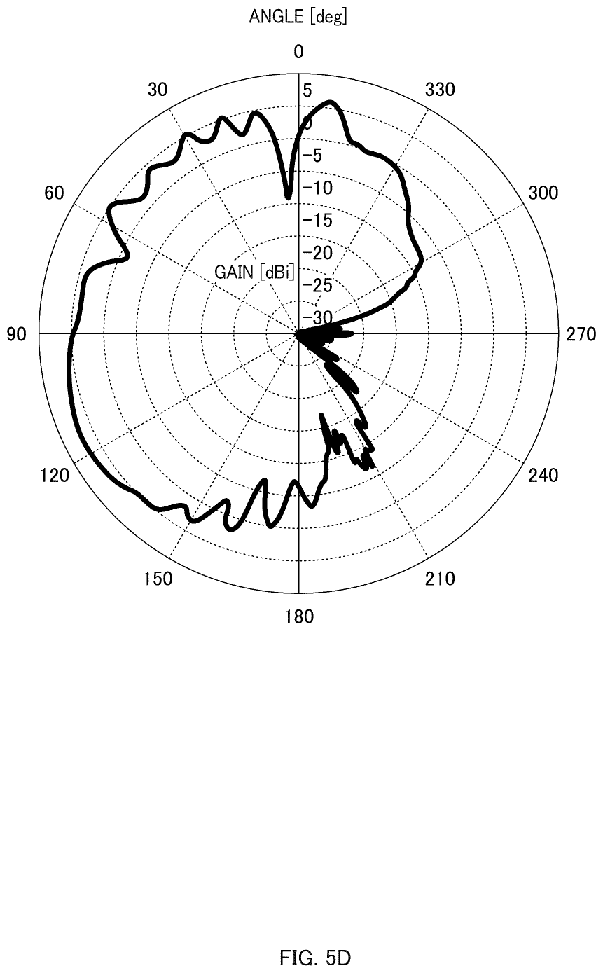

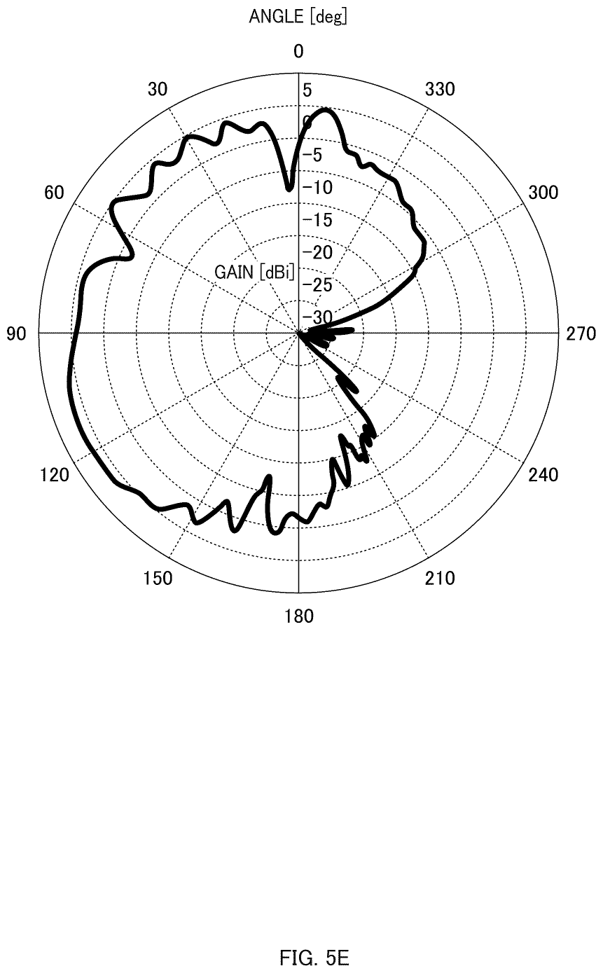

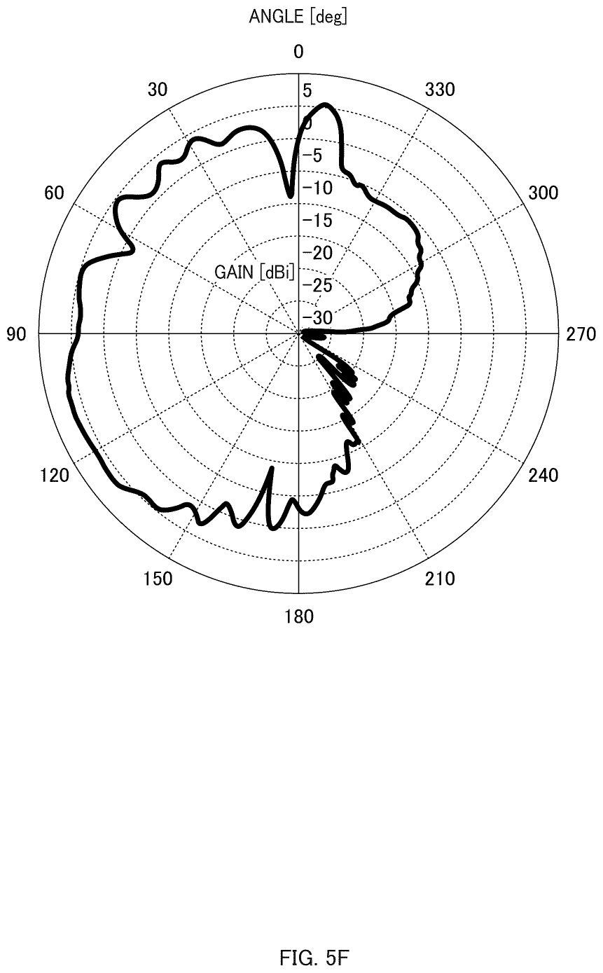

Next, with reference to FIGS. 5A to 5F, the characteristics of the antenna device 10 according to an embodiment of the present disclosure comprising the reflective element 20 will be described.

FIG. 5A is a diagram illustrating the radiation pattern of the antenna 11 of the antenna device 10 at the elevation angle E=0°.

Here, as illustrated in FIGS. 2A and 2B described above, assuming that the angle formed with the +Z direction (zenith direction) is an angle θ, the elevation angle E is defined as E=90°−θ. In other words, the elevation angle E refers to the angle with respect to the horizontal direction: when the elevation angle E is positive, it gives a direction upward from the horizontal direction, and when the elevation angle E is negative, it gives a direction downward from the horizontal direction.

The radiation pattern of the antenna 11 illustrated in FIG. 5A indicates the directivity in the horizontal plane. As described above, the antenna 11 is disposed at the left side mirror 3 of the mobile body 1. In this case, since the antenna 11 is affected by the structural portion 2 located on the right side relative to the side mirror 3, it becomes difficult to achieve a desired gain in the range on the right side of the mobile body 1. Thus, the directivity of the antenna 11 disposed on the left side mirror 3 of the mobile body 1 is considered as the directivity in the range on the left side of the mobile body 1, that is, in FIG. 5A, in the range of the angle of 0° to 180°.

In the radiation pattern of the antenna 11 illustrated in FIG. 5A, the direction of the angle 0° corresponds to the +X direction, the direction of the angle 90° corresponds to the +Y direction, the direction of the angle 180° corresponds to the −X direction, and the direction of the angle 270° corresponds to the −Y direction.

As described above, a plurality of antennas that support radio waves in the frequency band used for V2X, including the antenna 11, are located at the mobile body 1, and as the directivity of the entire antennas located at the mobile body 1, the diversity system may be employed. Accordingly, for example, another antenna 11 may be disposed at the right side mirror of the mobile body 1, and a larger signal out of the signals transmitted or received by the antennas 11 on the left and right sides may be selected. This makes it possible to achieve the desired directivity in all directions in the horizontal plane of the mobile body 1.

As illustrated in FIG. 5A, the antenna 11 according to an embodiment of the present disclosure has less ripples at the angle in the range of 0° to 180°, which is the range on the left side of the mobile body 1, and has good directivity.

FIG. 5B is a diagram illustrating the radiation pattern of the antenna 11 at an elevation angle E=−6°. FIG. 5C is a diagram illustrating the radiation pattern of the antenna 11 at the elevation angle E=−3°. FIG. 5D is a diagram illustrating the radiation pattern of the antenna 11 at the elevation angle E=3°.

FIG. 5E is a diagram illustrating the radiation pattern of the antenna 11 at the elevation angle E=6°. FIG. 5F is a diagram illustrating the radiation pattern of the antenna 11 at the elevation angle E=10°.

As illustrated in FIGS. 5B to 5F, the antenna 11 according to an embodiment of the present disclosure has less ripples not only at the elevation angle E=0° but also in the range of the elevation angle of E=−6° to 10° other than the elevation angle E=0°, and has good directivity. From the above, the antenna 11 according to an embodiment of the present disclosure has less ripples in the range of the elevation angles E=−6° to 10° in the range of the angle of 0° to 180°, which is the range on the left side of the mobile body 1, and has good directivity.

### COMPARATIVE EXAMPLE

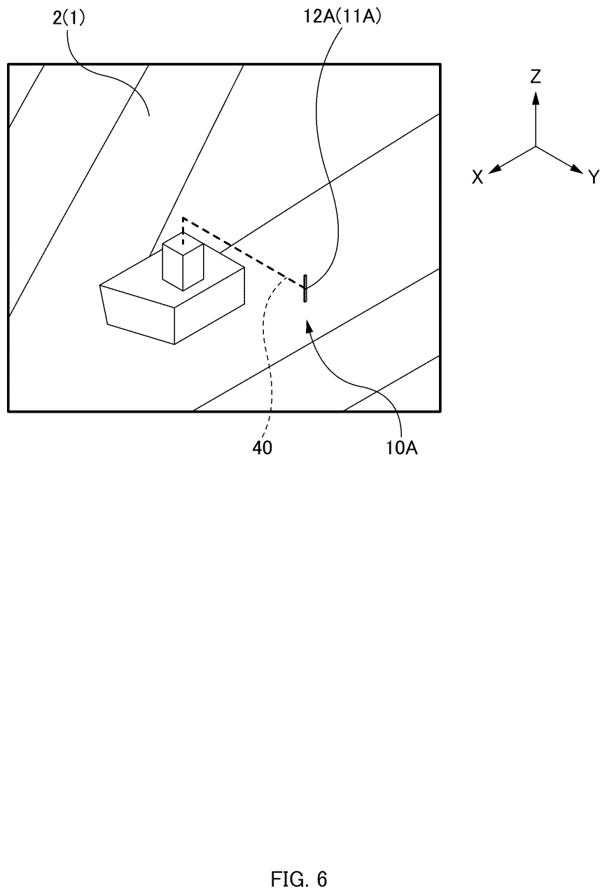

The characteristics of the antenna 11 according to an embodiment of the present disclosure described above will be described through comparison with an antenna 11A (antenna device 10A) of a comparative example with reference to FIGS. 6 to 8.

FIG. 6 is an enlarged perspective view of the antenna device 10A and its surroundings in the mobile body 1.

The antenna device 10A of the comparative example comprises the antenna 11A. The antenna 11A is an antenna that supports the radio waves in the frequency band used for V2X, and is configured as a dipole antenna, as in the antenna 11 according to an embodiment of the present disclosure. However, the antenna device 10A of the comparative example does not comprise the reflective element 20, unlike the antenna device 10 according to an embodiment of the present disclosure. Further, the antenna device 10A is a model for verification, and the mobile body 1 to which the antenna device 10A is disposed does not comprise the side mirror 3.

Note the coaxial cable 40 is connected to the antenna 11A of the antenna device 10A. In FIG. 6, the coaxial cable 40 connected to the antenna 11A is given by a dashed line. Further, in order to describe as a verification model, the illustration of the configuration of the antenna device 10A other than the antenna 11A is omitted in FIG. 6. For example, the antenna device 10A may comprise a support member to support the antenna 11A, and/or the antenna element 12A of the antenna 11A may be formed at the substrate as in the antenna 11 of the antenna device 10 according to an embodiment of the present disclosure. The details of other antennas 11A are omitted since they are the same as or similar to the antenna 11.

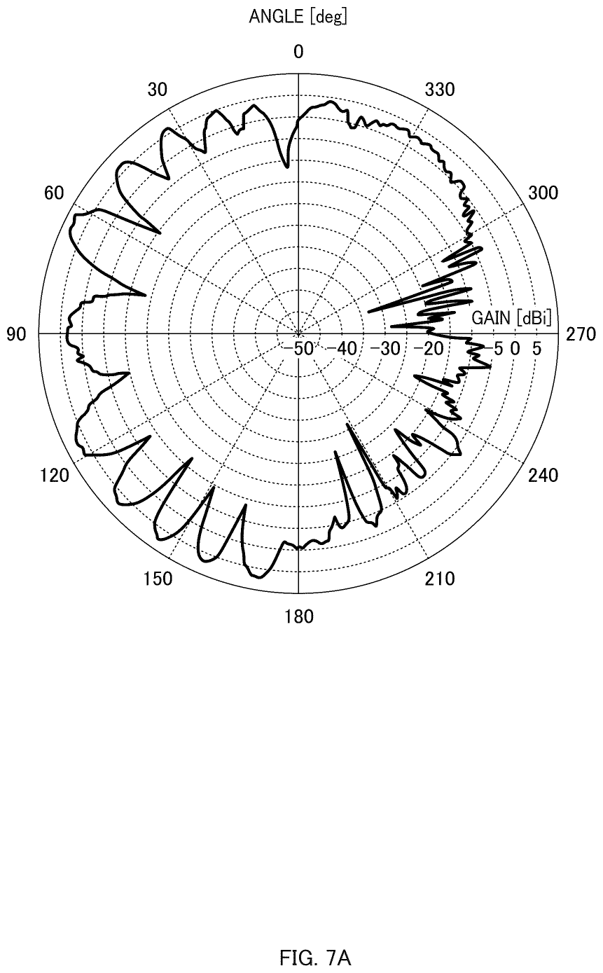

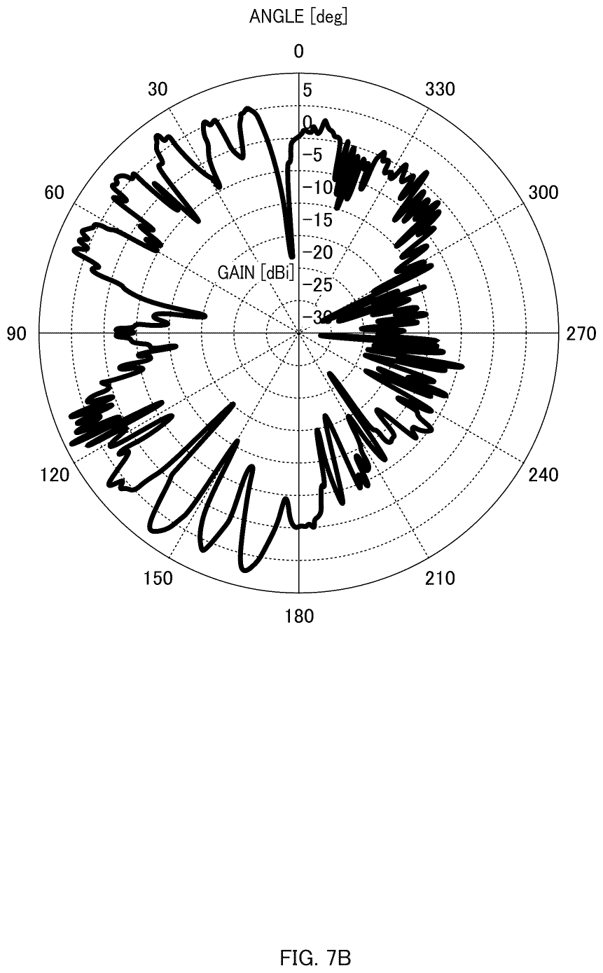

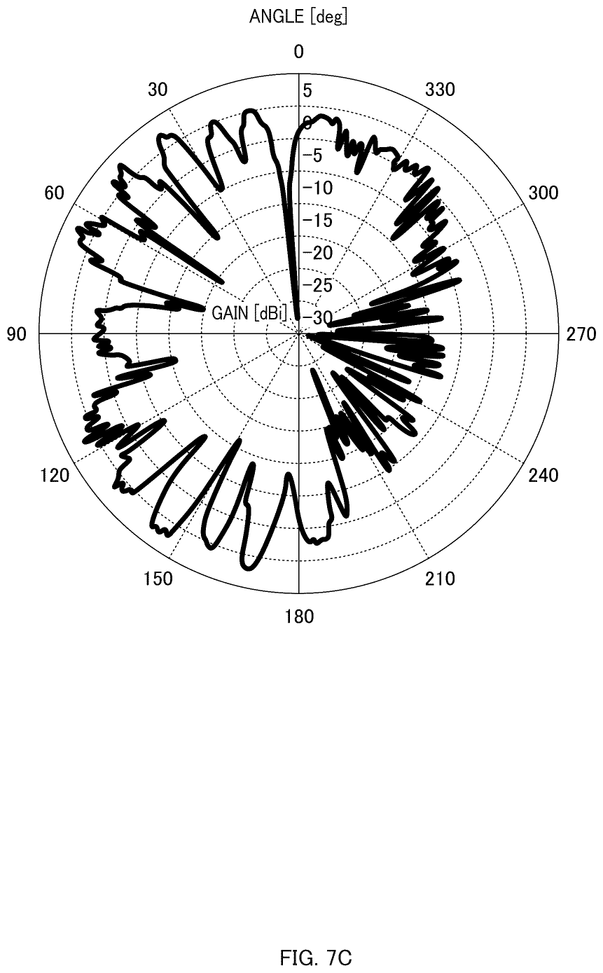

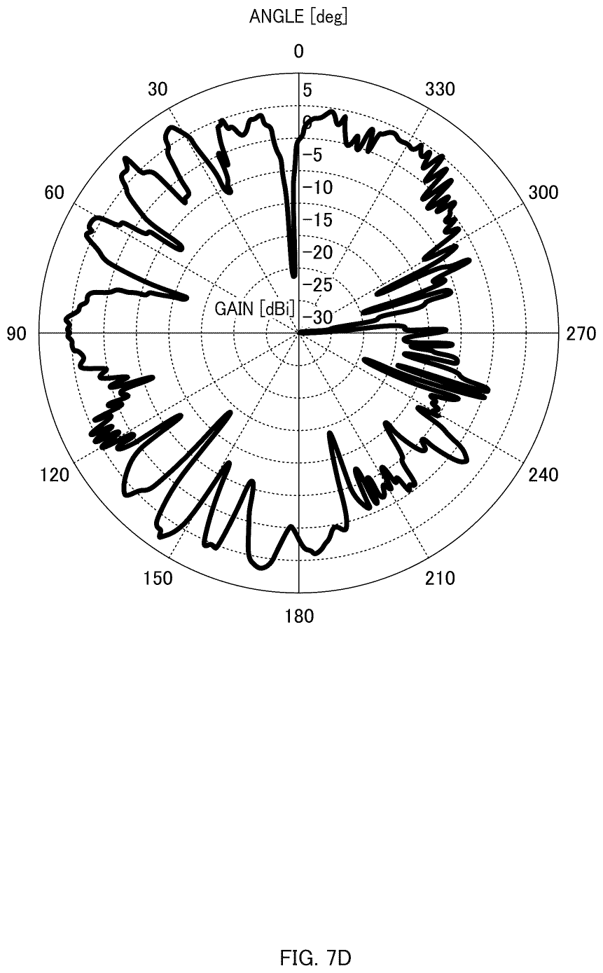

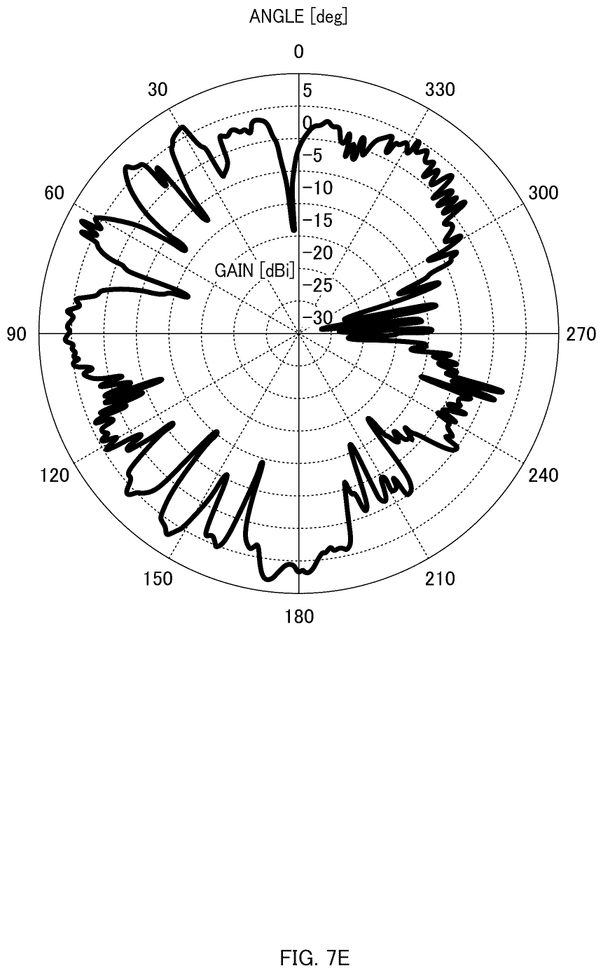

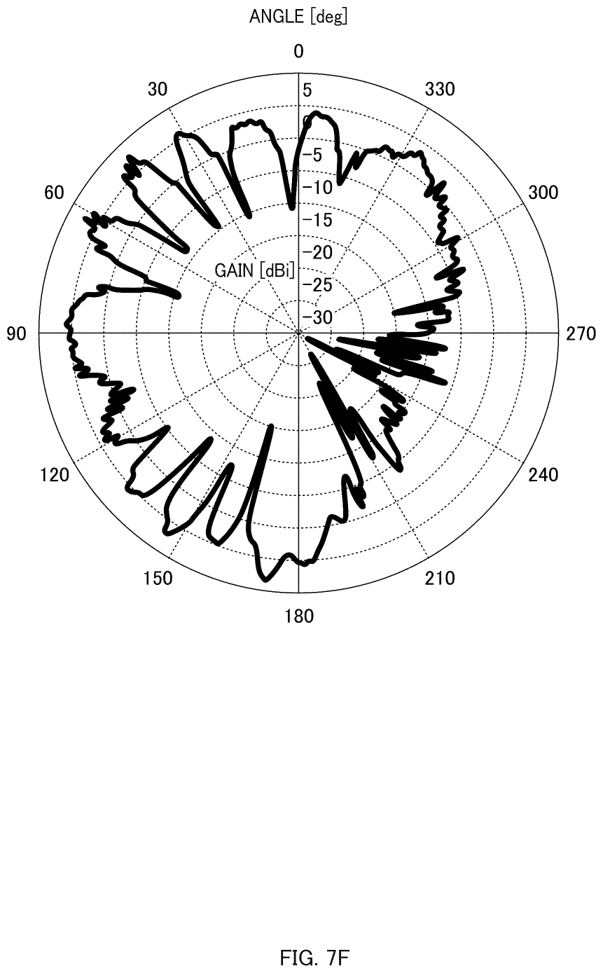

FIG. 7A is a diagram illustrating the radiation pattern of the antenna 11A at the elevation angle E=0°.

The radiation pattern of the antenna 11A of the comparative example illustrated in FIG. 7A gives the directivity in the horizontal plane at the elevation angle E=0°, as in the radiation pattern of the antenna 11 according to an embodiment of the present disclosure illustrated in FIG. 5A. The radiation pattern of the antenna 11A has more ripples than the radiation pattern of the antenna 11 illustrated in FIG. 5A. In other words, the antenna 11A has a significant gain deviation. Specifically, the antenna 11A has a gain deviation of nearly 20 dB between the maximum gain value and the minimum gain value.

This is because, in the antenna device 10A of the comparative example, the radio waves directly radiated from the antenna 11A (radio waves given by solid lines in FIG. 1) and the radio waves scattered at the structural portion 2 (radio waves given by the dashed lines in FIG. 1) interfere with each other, as described above, to thereby generate the radio waves in the direction in which the gains weaken each other and the direction in which the gains strengthen each other when viewed from the antenna 11A. Then, this is because the directivity of the antenna 11A deteriorates due to significant gain deviation.

FIG. 7B is a diagram illustrating the radiation pattern of the antenna 11A at the elevation angle E=−6°. FIG. 7C is a diagram illustrating the radiation pattern of the antenna 11A at the elevation angle E=−3°. FIG. 7D is a diagram illustrating the radiation pattern of the antenna 11A at the elevation angle E=3°.

FIG. 7E is a diagram illustrating the radiation pattern of the antenna 11A at the elevation angle E=6°. FIG. 7F is a diagram illustrating the radiation pattern of the antenna 11A at the elevation angle E=10°.

As illustrated in FIGS. 7B to 7F, the antenna 11A of the comparative example has more ripples not only at the elevation angle E=0°, but also in the range of the elevation angle E=−6° to 10° other than the elevation angle E=0°, and the directivity of the antenna 11A deteriorates. That is, the antenna 11A of the comparative example has significant gain deviation in the range of the elevation angle E=−6° to 10°.

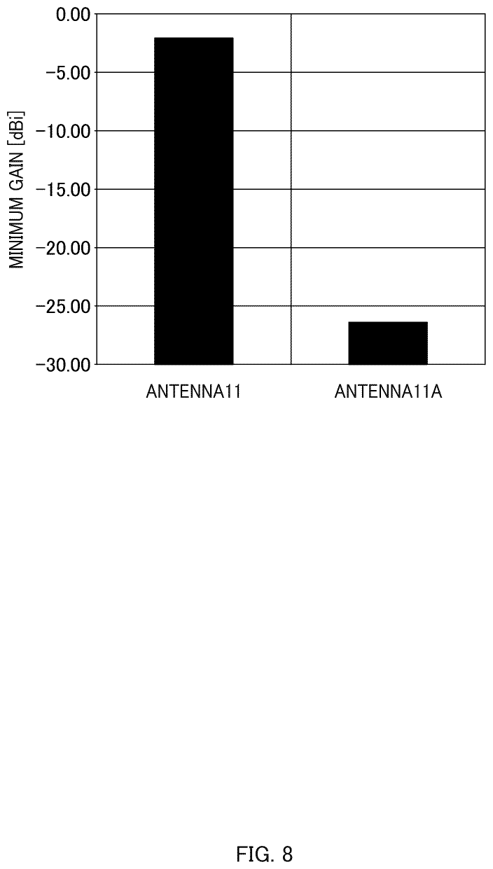

FIG. 8 is a diagram illustrating the minimum gains of the antenna 11 and the antenna 11A.

The following limits the range to a predetermined range of the angle (here, 10° to 160°) in the range on the left side of the mobile body 1 (0° to 180°), and compares the minimum gain at the elevation angle E=0° in the antenna 11 according to an embodiment of the present disclosure and the minimum gain at the elevation angle E=0° of the antenna 11A of the comparative example. Here, the term “minimum gain” refers to the minimum value of the gain in the predetermined range of the angle (here, 10° to 160°). The reason why the range other than the predetermined range of the angle (here, 0° to 10° and 160° to 180°) is excluded from the range to be compared is that the influence of the structural portion 2 of the mobile body 1 is large outside the predetermined range of the angle and it is difficult to achieve the desired gain.

As illustrated in FIG. 8, at the elevation angle E=0°, the antenna 11A of the comparative example has the minimum gain significantly smaller than that of the antenna 11 according to an embodiment of the present disclosure. That is, in the antenna 11A of the comparative example, when compared with the antenna 11 according to an embodiment of the present disclosure, it can be seen that the gain deviation is large and the minimum gain is significantly small.

Although the illustration of detailed comparison results is omitted, the antenna 11A of the comparative example has the minimum gain significantly smaller than that of the antenna 11 according to an embodiment of the present disclosure not only at the elevation angle E=0° but also in the range of the elevation angle E=−6° to 10° other than the elevation angle E=0°. That is, in the antenna 11A of the comparison example, when compared with the antenna 11 according to an embodiment of the present disclosure in the range of the elevation angle E=−6° to 10°, the gain deviation is large and the minimum gain is significantly small.

From the above, the antenna device 10 according to an embodiment of the present disclosure comprises the reflective element 20 located between the structural portion 2 and the antenna element 12 in the radiation direction of radio waves, thereby being able to suppress the propagation of radio waves to the structural portion 2, and suppress the gain deviation while having the desired directivity. Accordingly, it is possible to suppress the deterioration of the directivity of the antenna 11 caused by the radio wave scattering.

### <<Verification of Dimensions and the Like of Reflective Element 20>>

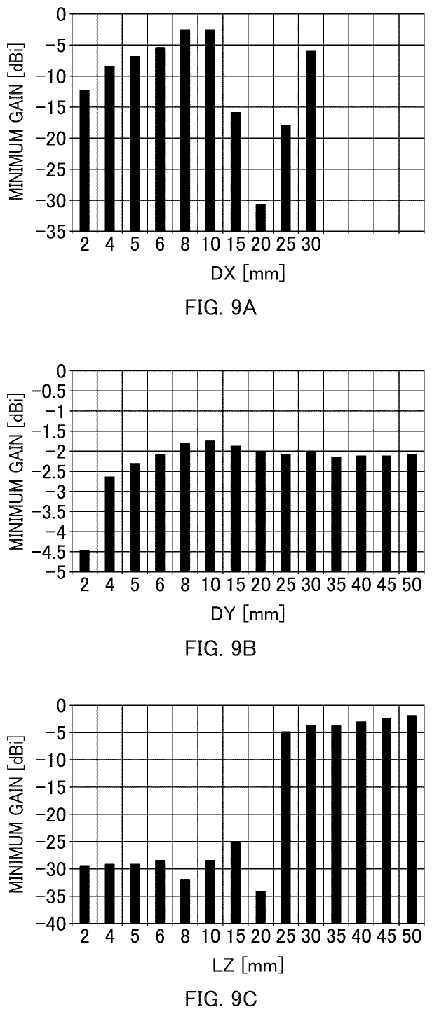

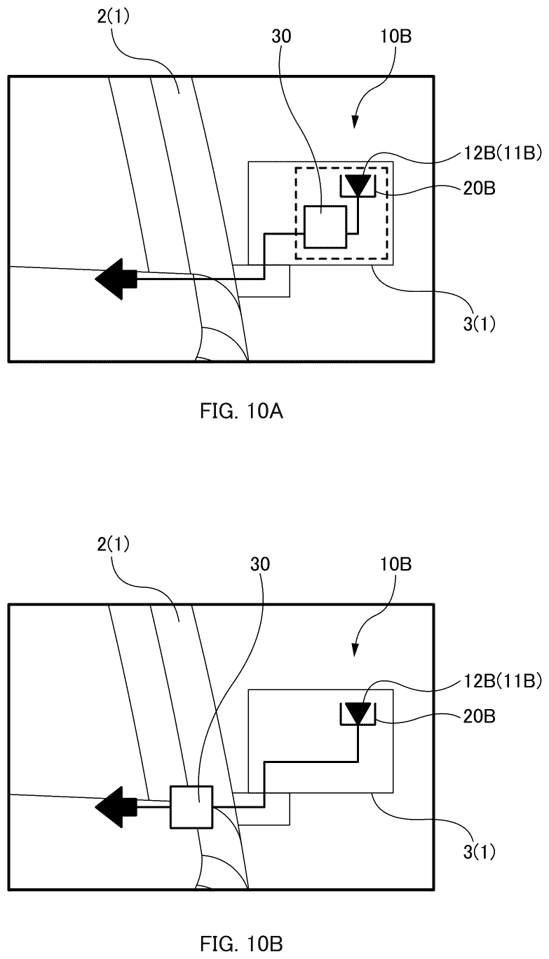

Next, while referring again to FIGS. 4A to 4D described above and newly referring to FIGS. 9A to 9C, desirable dimensions of the reflective element 20 and the like will be verified.

As described above, in the antenna device 10 according to an embodiment of the present disclosure, the first reflective portion 21 and the second reflective portion 22 of the reflective element 20 are located so as to sandwich the antenna element 12 of the antenna 11 in the X direction. Here, it is desirable that the distance in the X direction between the antenna element 12 and the reflective element 20 (the first reflective portion 21 and the second reflective portion 22) is such an appropriate distance that they are not too close to or too apart from each other. This is because it can be seen that if the antenna element 12 and the reflective element 20 are too close in the X direction, the radiation of radio waves by the antenna 11 is affected, and if the antenna element 12 and the reflective element 20 are too apart, the effect of mitigating the radio wave scattering at the structural portion 2 is weakened.

In order to verify such an appropriate distance in the X direction, a first distance DX1 and a second distance DX2 are defined first.

As illustrated in FIG. 4D, the first distance DX1 is the separation distance in the X direction between the surface of the first reflective portion 21 closer to the antenna element 12 (antenna 11) and the antenna element 12. Further, as illustrated in FIG. 4D, the second distance DX2 is the separation distance in the X direction between the surface of the second reflective portion 22 closer to the antenna element 12 (antenna 11) and the antenna element 12.

Further, it is desirable that the distance in the Y direction between the antenna element 12 and the reflective element 20 (third reflective portion 23) is an appropriate distance. This is because it can be seen that if the antenna element 12 and the reflective element 20 are too close in the Y direction, the radiation of radio waves by the antenna 11 is affected.

In order to verify such an appropriate distance in the Y direction, a third distance DY is defined. As illustrated in FIG. 4A, the third distance DY is the separation distance in the Y direction between the surface of the third reflective portion 23 closer to the antenna element 12 (antenna 11) and the antenna element 12.

Further, in order to verify the appropriate length of the reflective element 20 in the Z direction, a length LZ is defined.

The length LZ is the length of the reflective element 20 in the Z direction, as illustrated in FIGS. 4B and 4C.

FIG. 9A is a diagram illustrating the relationship between the distance DX in the antenna device 10 and the minimum gain of the antenna 11.

FIG. 9A illustrates the relationship between the minimum gain of the antenna 11 and the distance DX, when the first distance DX1 and the second distance DX2 are changed, with the first distance DX1 and the second distance DX2 being maintained equal to each other.

Thus, the distance DX in the antenna device 10 illustrated in FIG. 9A indicates both the above-described first distance DX1 and second distance DX2. According to the graph in FIG. 9A, it can be seen that when the distance DX exceeds 15 mm, the minimum gain of the antenna 11 suddenly decreases. Thus, the distance DX is preferably 15 mm or less, more preferably, 5 mm or more and 10 mm or less.

If the range of the above preferable distance DX is converted in terms of the wavelength of the frequency (5.9 GHz) of the radio waves supported by the antenna 11, the distance DX is preferably one third or less of the wavelength of the radio waves supported by the antenna 11, more preferably, one tenth or more and one fifth or less of the wavelength of the radio waves supported by the antenna 11.

In the above description, the preferable range of distance when the first distance DX1 is equal to the second distance DX2 is described. That is, both the first distance DX1 and the second distance DX2 are preferably one third or less of the wavelength of the radio waves supported by the antenna 11, more preferably, one tenth or more and one fifth or less of the wavelength of the radio waves supported by the antenna 11. However, one of the first distance DX1 or the second distance DX2 may be preferably one third or less of the wavelength of the radio waves supported by the antenna 11, more preferably, one tenth or more and one fifth or less of the wavelength of the radio waves supported by the antenna 11.

FIG. 9B is a diagram illustrating the relationship between the distance DY in the antenna device 10 and the minimum gain in the antenna 11.

According to the graph in FIG. 9B, it can be seen that when the distance DY is less than 4 mm, the minimum gain of the antenna 11 significantly decreases. Thus, the distance DY is preferably 4 mm or more, more preferably, 5 mm or more.

When the range of the above desirable distance DY is converted in terms of the wavelength of the frequency (5.9 GHz) of the radio waves supported by the antenna 11, the distance DY is preferably one tenth or more of the wavelength of the radio waves supported by the antenna 11.

FIG. 9C is a diagram illustrating the relationship between the length LZ in the antenna device 10 and the minimum gain of the antenna 11.

According to the graph in FIG. 9C, it can be seen that when the length LZ is less than 25 mm, the minimum gain of the antenna 11 significantly decreases. Thus, the length LZ is preferably 25 mm or more.

### <<Compensator 30>>

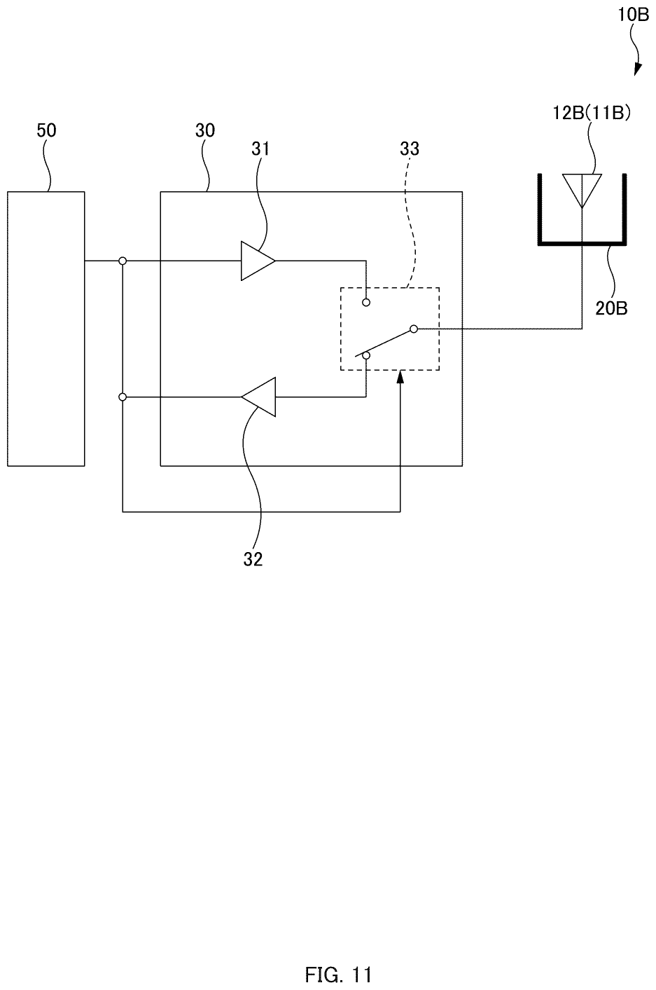

In the case of the antenna supporting the radio waves in the frequency band used for V2X as in an embodiment of the present disclosure, and when the coaxial cable connected to the antenna is routed, signal loss may increase. The antenna device according to an embodiment of the present disclosure may further include a compensator to compensate the gain corresponding to an amount of such signal loss. Thus, the antenna device 10B comprising a compensator 30 will be described with reference to FIGS. 10A, 10B, and 11.

FIG. 10A is an explanatory diagram of the antenna device 10B comprising the compensator 30. FIG. 10B is an explanatory diagram of the antenna device 10B in which the location of the compensator 30 is changed. FIG. 11 is a block diagram of the circuit of the compensator 30.

The antenna device 10B comprises an antenna 11B, a reflective element 20B, and the compensator 30. The antenna 11B is the same as the above-described antenna 11 of an embodiment of the present disclosure, and includes an antenna element 12B. The reflective element 20B is the same as the above-described reflective element 20, and is located so as to cover three sides on the structural portion 2 side (i.e., on the −X direction side, +X direction side, and −Y direction side) with respect to the antenna element 12B.

The compensator 30 is a device to compensate the gain corresponding to an amount of signal loss in the coaxial cable connected to the antenna 11B. The compensator 30 is connected between the antenna 11B and an electronic control unit (ECU) 50. The compensator 30 includes a first amplifier 31, a second amplifier 32, and a switch 33, as illustrated in FIG. 11.

The first amplifier 31 is an amplifier (so-called power amplifier) to amplify the radio waves that are transmitted by the antenna 11B.

The second amplifier 32 is an amplifier (so-called low noise amplifier) to amplify the radio waves that are received by the antenna 11B. The switch 33 is to switch between a path having the first amplifier 31 and a path having the second amplifier 32. That is, the compensator 30 includes a circuit to amplify the signals transmitted and received by the antenna 11B. Here, the term “path” is a route through which a signal passes.

In addition, between the compensator 30 and the ECU 50, communicated are the signal to transmit the amplification factor of the compensator 30 to the ECU 50 in real time, and the signal used for communication with other terminals through the antenna 11B, in addition to the power to operate the first amplifier 31 and the second amplifier 32, and the signal to instruct switching of the switch 33. Further, each of the signals may be communicated between the compensator 30 and the ECU 50 through the same coaxial cable.

Further, signals may be communicated through the same coaxial cable, partially the same coaxial cable, or respectively different coaxial cables.

In the antenna device 10B according to an embodiment of the present disclosure, the compensator 30 is disposed within the side mirror 3, together with the antenna 11B and the reflective element 20B, as illustrated in FIG. 10A. In other words, the compensator 30 is disposed close to the antenna 11B. In this case, the reflective element 20B is located between the compensator 30 and the antenna element 12B in the radiation direction of radio waves. This makes it possible to suppress the influence of the radio waves of the antenna 11B on the compensator 30 (particularly, the first amplifier 31 and the second amplifier 32). In other words, the reflective element 20B can reflect the radio waves supported by the antenna 11 and also function as a shield cover for the compensator 30. This makes it possible to easily achieve saving space of the antenna device 10B and make it composite. However, the compensator 30 may be disposed outside the side mirror 3, as illustrated in FIG. 10B.

### ==Modification Example of Reflective Element==

### <<Side Mirror 3 Functioning as Reflective Element>>

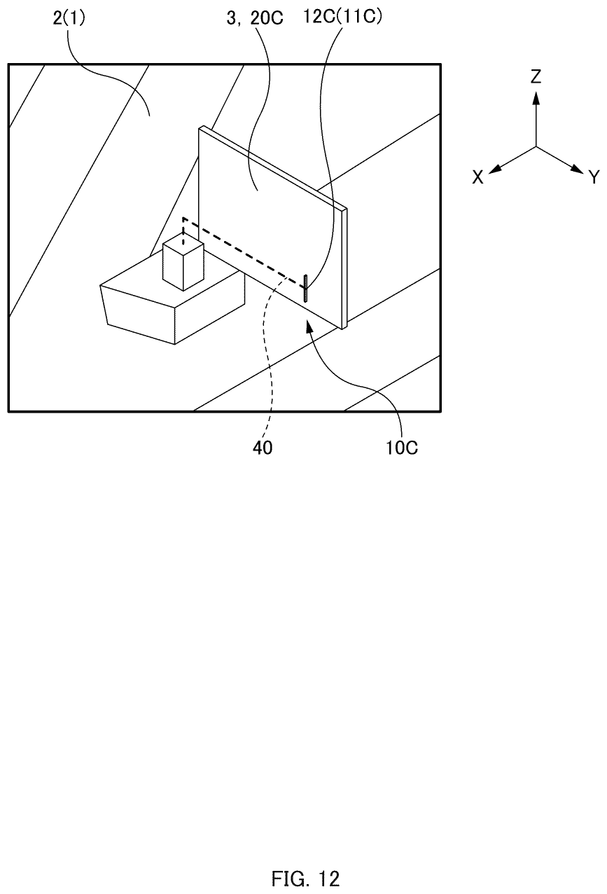

As described above, the reflective element 20 of the antenna device 10 is a member to reflect the radio waves supported by the antenna 11, and is formed of a conductor. The reflective element may be of an aspect other than that as of the above-described reflective element 20. For example, since the side mirror 3 of the mobile body 1 is formed of a conductor, as illustrated in FIG. 12, the side mirror 3 may function as a reflective element.

FIG. 12 is an enlarged perspective view of an antenna device 10C and its surroundings in the mobile body 1.

The antenna device 10C comprises an antenna 11C and a reflective element 20C. The antenna 11C is the same as the antenna 11A of the above-described comparative example, and includes an antenna element 12C. In the antenna device 10C, the side mirror 3 of the mobile body 1 may be the reflective element 20C. The reflective element 20C which is the side mirror 3 is located on the rear side (−X direction side) of the antenna element 12C.

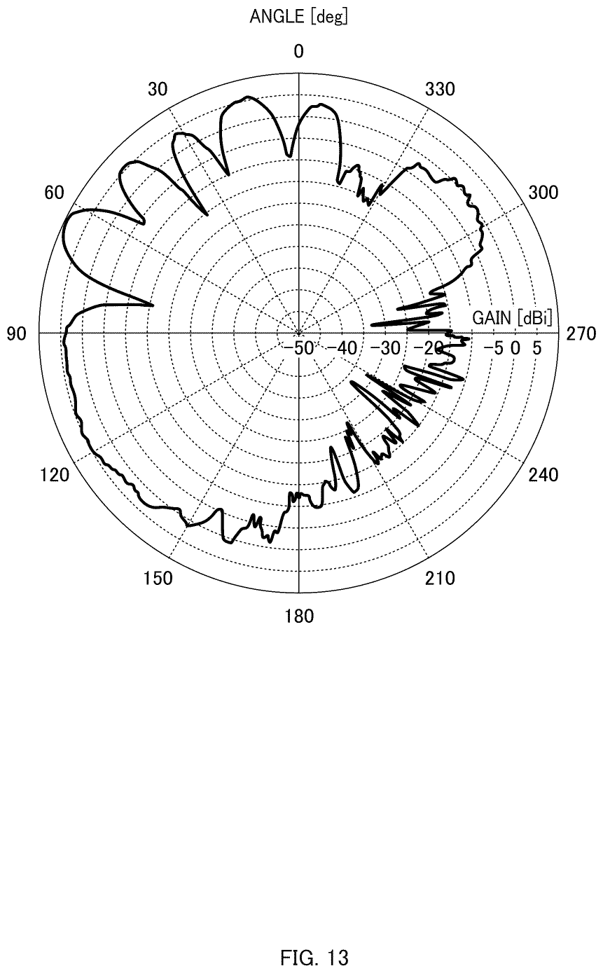

FIG. 13 is a diagram illustrating the radiation pattern of the antenna 11C at the elevation angle E=0°.

In FIG. 13, the radiation pattern in the horizontal plane is illustrated as in FIG. 5A described above. As illustrated in FIG. 13, the antenna 11C has less ripples and good directivity in the range of the angle of 90° to 180° in which the reflective element 20C is disposed, in the angle of 0° to 180°. However, in the range of the angle of 0° to 90°, there is where the gain deviation is large. If it is acceptable that there is such a range in which the gain deviation is large, the antenna 11C may be disposed at a position at which the side mirror 3 of the mobile body 1 functions as the reflective element.

With reference to FIG. 13, the radiation pattern of the antenna 11C at the elevation angle E=0° has been described. Although detailed verification results are omitted, the antenna 11C has less ripples and good directivity in the range of the angle of 90° to 180° in which the reflective element 20C is disposed, not only at the elevation angle E=0° but also in the range of the elevation angle E=−6° to 10° other than the elevation angle E=0°.

<<Linear portion 24>>

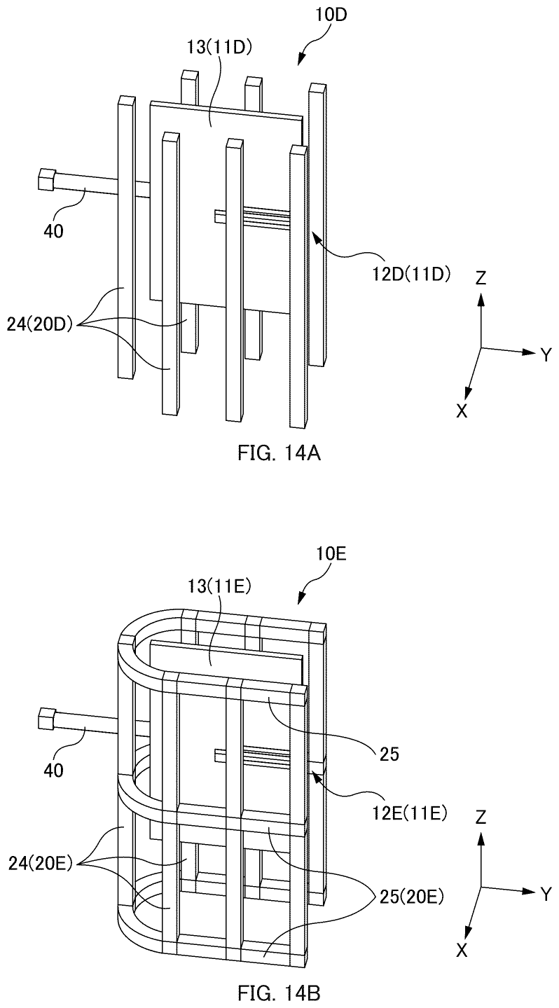

The reflective element may be of an aspect other than that as of the above-described reflective element 20. For example, as illustrated in FIGS. 14A and 14B, the side mirror 3 of the mobile body 1 may include a plurality of linear portions that reflect the linearly polarized radio waves.

FIG. 14A is a perspective view of an antenna device 10D.

The antenna device 10D includes an antenna 11D and a reflective element 20D. The antenna 11D is the same as the antenna 11 according to an embodiment of the present disclosure described above, and includes an antenna element 12D. The reflective element 20D includes a plurality of linear portions 24. Each of the linear portions 24 is formed of a conductor, and extends in the Z direction so as to reflect the linearly polarized radio waves supported by the antenna 11D. This also makes it possible to suppress the deterioration of the directivity of the antenna 11D caused by the radio wave scattering. The reflective element 20D may be configured with, for example, a sheet metal, a linear conductor, or a conductive pattern printed on a substrate.

FIG. 14B is a perspective view of an antenna device 10E.

The antenna device 10E comprises an antenna 11E and a reflective element 20E. The antenna 11E is the same as the antenna 11 according to an embodiment of the present disclosure described above, and includes an antenna element 12E. The reflective element 20E includes the plurality of linear portions 24 that are the same as the reflective elements 20D described above, and a bridge portion 25 that connects the plurality of linear portions 24 in the lateral direction. Each of the linear portions 24 is formed of a conductor, and extends in the Z direction so as to reflect the linearly polarized radio waves supported by the antenna 11D. This also makes it possible to suppress the deterioration of the directivity of the antenna 11E caused by the radio wave scattering. In the antenna device 10E, with the bridge portion 25 connecting the plurality of linear portions 24, it is possible to suppress the propagation of the radio waves to the structural portion 2, thereby suppressing the scattering at the structural portion 2, while the bridge portion 25 supports the plurality of linear portions 24. The reflective element 20E may be configured with, for example, a sheet metal, a linear conductor, or a conductive pattern printed on a substrate.

### <<Other Modification Examples>>>

As described above, the reflective element 20 of the antenna device 10 includes the first reflective portion 21, the second reflective portion 22, and the third reflective portion 23. However, the reflective element 20, as with an antenna device 10F and an antenna device 10G which will be described later, may include part (only any two or any one) of the first reflective portion 21, the second reflective portion 22, and the third reflective portion 23.

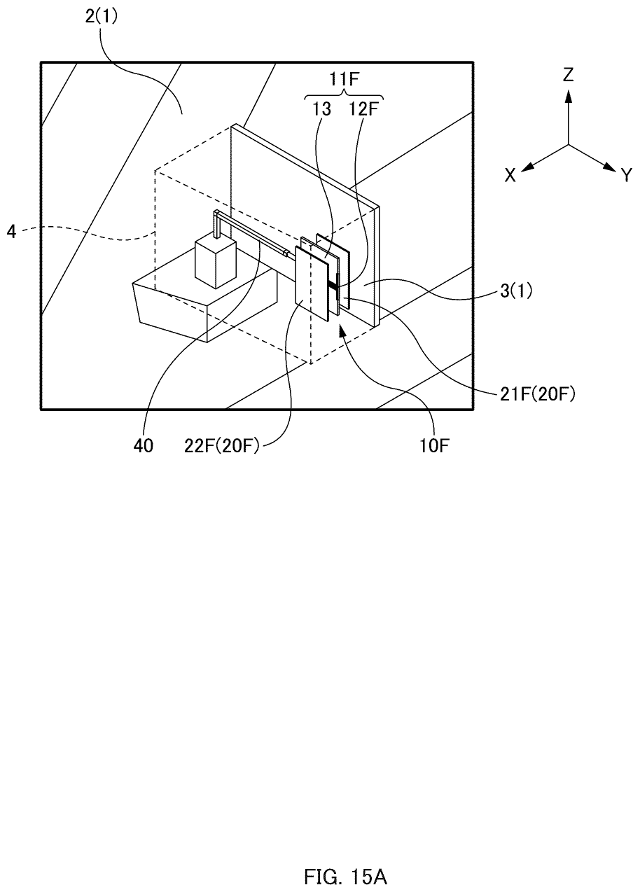

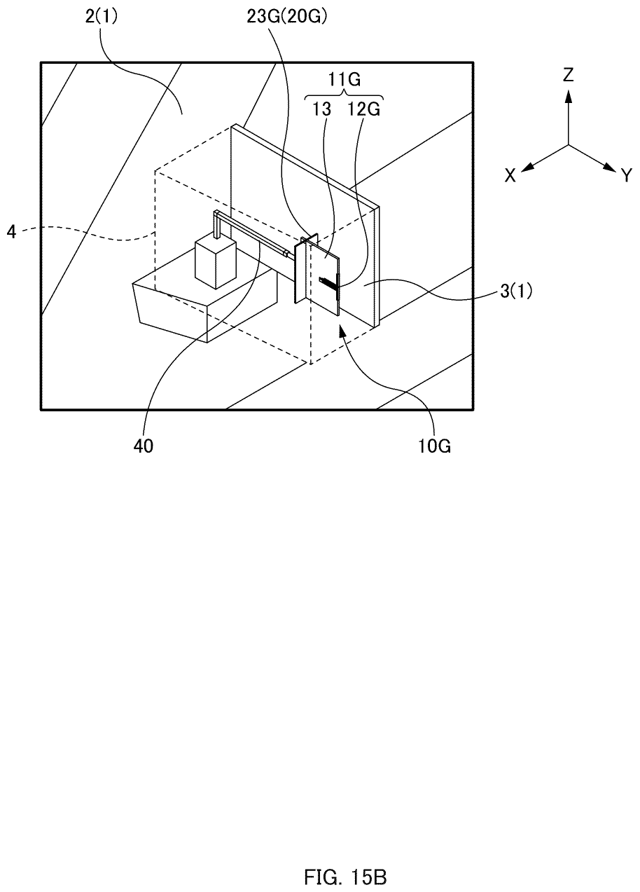

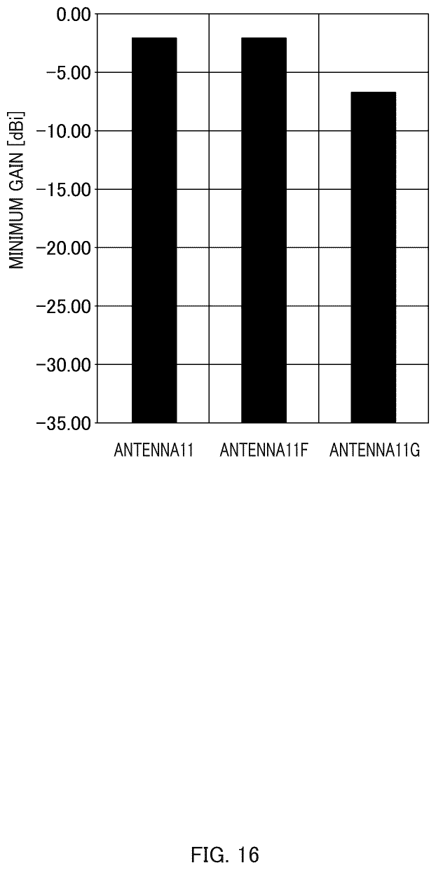

FIG. 15A is an enlarged perspective view of the antenna device 10F and its surroundings in the mobile body 1. FIG. 15B is an enlarged perspective view of the antenna device 10G and its surroundings in the mobile body 1.

A reflective element 20F of the antenna device 10F only includes a first reflective portion 21F and a second reflective portion 22F, as illustrated in FIG. 15A. In other words, the reflective element 20F of the antenna device 10F does not include the third reflective portion 23, as compared with the reflective element 20 of the antenna device 10 illustrated in FIG. 2B described above.

Further, a reflective element 20G of the antenna device 10G only includes the third reflective portion 23, as illustrated in FIG. 15B. In other words, the reflective element 20G of the antenna device 10G does not include the first reflective portion 21 or the second reflective portion 22, as compared with the reflective element 20 of the antenna device 10 illustrated in FIG. 2B described above.

FIG. 16 is a diagram illustrating the minimum gains of the antenna 11, the antenna 11F, and the antenna 11G.

In FIG. 16, with the range of the angle being limited to a predetermined range of the angle (here, 10° to 160°) in the range on the left side of the mobile body 1 (0° to 180°), the minimum gains of the antenna 11F and the antenna 11G are compared with the minimum gain of the antenna 11 according to an embodiment of the present disclosure illustrated in FIG. 8 described above, at the elevation angle E=0°.

As illustrated in FIG. 16, although the minimum gain of the antenna 11G is slightly smaller, it can be seen that the minimum gains of the antenna 11F and the antenna 11G are substantially equivalent to the minimum gain of the antenna 11. Although the illustration of detailed comparison results are omitted, the minimum gains of the antenna 11F and the antenna 11G are substantially equivalent to the minimum gain of the antenna 11, not only at the elevation angle E=0° but also in the range of the elevation angle E=−6° to 10° other than the elevation angle E=0°.

That is, even in the antenna device 10F and the antenna device 10G, it is possible to suppress the propagation of radio waves to the structural portion 2, and suppress the gain deviation while having the desired directivity, as in the antenna device 10.

Accordingly, it is possible to suppress the deterioration of the directivity of the antenna 11F and the antenna 11G caused by the radio wave scattering.

As described above, the reflective element 20 of the antenna device 10 includes the first reflective portion 21, the second reflective portion 22, and the third reflective portion 23. However, as in antenna devices 10H to 10J, which will be described later, the reflective element 20 includes at least part of the first reflective portion 21, the second reflective portion 22, and the third reflective portion 23, and may further include reflective portions (reflective portions disposed above and below the antenna element).

FIG. 17A is an enlarged perspective view of the antenna device 10H and its surroundings in the mobile body 1. FIG. 17B is an enlarged perspective view of the antenna device 10I and its surroundings in the mobile body 1. FIG. 17C is an enlarged perspective view of the antenna device 10J and its surroundings in the mobile body 1.

The reflective element 20H of the antenna device 10H includes a first reflective portion 21H, a second reflective portion 22H, and a third reflective portion 23H, as illustrated in FIG. 17A. Further, the reflective element 20H includes a fourth reflective portion 26H disposed above the antenna element 12H, and a fifth reflective portion 27H disposed below the antenna element 12H. In other words, the reflective element 20H of the antenna device 10H further includes the fourth reflective portion 26H and the fifth reflective portion 27H, as compared with the reflective element 20 of the antenna device 10 illustrated in FIG. 2B described above.

The reflective element 20I of the antenna device 10I includes a first reflective portion 21I and a second reflective portion 22I, as illustrated in FIG. 17B. Further, the reflective element 20I includes a fourth reflective portion 26I disposed above an antenna element 12I and a fifth reflective portion 27I disposed below the antenna element 12I. In other words, the reflective element 20I of the antenna device 10I further includes the fourth reflective portion 26I and the fifth reflective portion 27I, as compared with the reflective element 20F of the antenna device 10F illustrated in FIG. 15A described above.

A reflective element 20J of the antenna device 10J includes a third reflective portion 23J, as illustrated in FIG. 17C. Further, the reflective element 20J includes a fourth reflective portion 26J disposed above the antenna element 12J, and a fifth reflective portion 27J disposed below the antenna element 12J. In other words, the reflective element 20J of the antenna device 10J further includes the fourth reflective portion 26J and the fifth reflective portion 27J, as compared with the reflective element 20G of the antenna device 10G illustrated in FIG. 15B described above.

FIG. 17D is an enlarged perspective view of an antenna device 10K and its surroundings in the mobile body 1.

As a reference example of the antenna devices 10H to 10J described above, in the antenna device 10K, the reflective element 20 is configured with only the reflective portions disposed above and below the antenna element. That is, the reflective element 20K of the antenna device 10K only includes a fourth reflective portion 26K and a fifth reflective portion 27K, as illustrated in FIG. 17D.

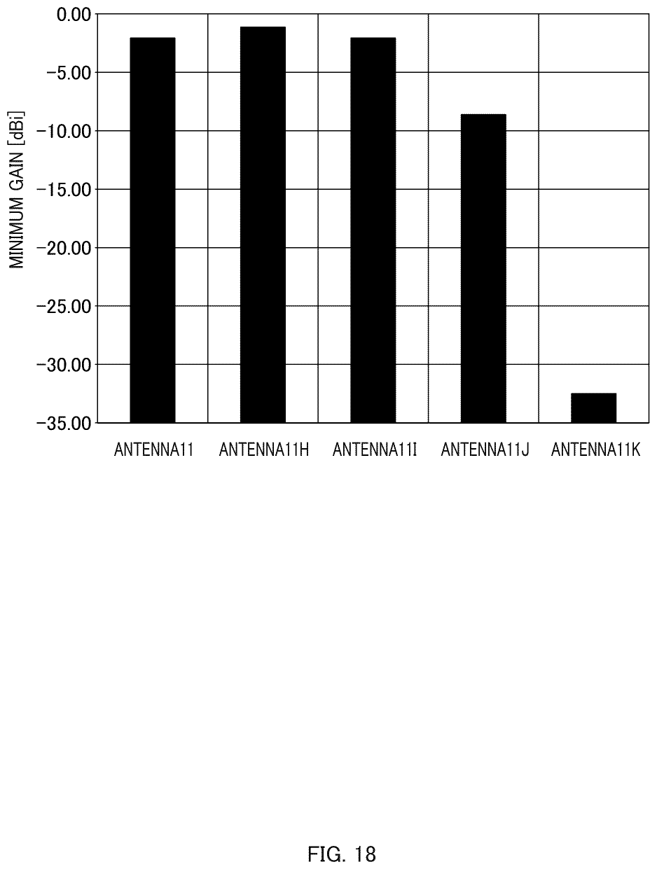

FIG. 18 is a diagram illustrating the minimum gains of the antennas 11 and 11H to 11K.

In FIG. 18, with the range of the angle being limited to a predetermined range of the angle (here, 10° to 160°) in the range on the left side of the mobile body 1 (0° to 180°), the minimum gains of the antennas 11H to 11K are compared with the minimum gain of the antenna 11 according to an embodiment of the present disclosure illustrated in FIG. 8 described above, at the elevation angle E=0°.

As illustrated in FIG. 18, the minimum gains of the antennas 11H and 11I are larger than the minimum gain of the antenna 11. Further, although the minimum gain of the antenna 11J is slightly smaller than the minimum gain of the antenna 11, it can be seen that they are substantially equivalent. Although the illustration of detailed comparison results are omitted, the minimum gains of the antennas 11H and 11I are larger than the minimum gain of the antenna 11, not only at the elevation angle E=0° but also in the range of the elevation angle E=−6° to 10° other than the elevation angle E=0°. Further, the minimum gain of the antenna 11J is substantially equivalent to the minimum gain of the antenna 11, not only at the elevation angle E=0° but also in the range of the elevation angle E=−6° to 10° other than the elevation angle E=0°.

That is, even in the antenna devices 10H to 10J, it is possible to suppress the propagation of the radio waves to the structural portion 2, and suppress the gain deviations while having the desired directivity, as in the antenna device 10. Accordingly, it is possible to suppress the deterioration of the directivity of the antennas 11H to 11J caused by the radio wave scattering. Further, as in the antenna device 10H and the antenna device 10I, with the reflective portions being added above and below the antenna element, it is possible to further suppress the propagation of radio waves to the structural portion 2, and suppress the gain deviation while having the desired directivity.

As illustrated in FIG. 18, at the elevation angle E=0°, the minimum gain of the antenna 11K of the reference example is significantly smaller than the minimum gains of the antenna 11 according to an embodiment of the present disclosure and the antennas 11H to the antenna 11J of the modification examples. Although the illustration of detailed comparison results are omitted, the minimum gain of the antenna 11K of the reference example is significantly smaller than the minimum gains of the antenna 11 according to an embodiment of the present disclosure and the antenna 11H to the antenna 11J of the modification examples, not only at the elevation angle E=0° but also in the range of the elevation angle E=−6° to 10° other than the elevation angle E=0°. That is, it can be seen that the reflective portions disposed above and below the antenna element have a small effect of suppressing the deterioration of the directivity of the antenna, by themselves, and thus are additional elements.

Embodiments and modification examples of the present disclosure have been described above with reference to the drawings, but these are just examples of the present disclosure, and various configurations other than those described above may be employed.

==Summary==

According to the present Description, an antenna device of aspects described below is provided.

### (Aspect 1)

An aspect 1 is the antenna device 10 disposed at the mobile body 1 that includes the structural portion 2, the antenna device 10 comprising: the antenna element 12 disposed apart from the structural portion 2, the antenna element 12 supporting radio waves in a predetermined frequency band; and the reflective element 20 configured to reflect the radio waves, wherein the reflective element 20 is located between the structural portion 2 and the antenna element 12 in the radiation direction of the radio waves.

According to an aspect described above, it is possible to suppress the deterioration of the directivity of the antenna caused by the radio wave scattering.

### (Aspect 2)

In an aspect 2, the reflective element 20 includes the first reflective portion 21 and the second reflective portion 22, a first direction is a direction in which the antenna element 12 is separated from the structural portion 2, and the antenna element 12 is located between the first reflective portion 21 and the second reflective portion 22 in a second direction perpendicular to the first direction.

The “first direction” corresponds to the “Y direction” in an aspect described above. The “second direction” corresponds to the “X direction” in an aspect described above.

According to an aspect described above, it is possible to further suppress the deterioration of the directivity of the antenna caused by the radio wave scattering.

### (Aspect 3)

In an aspect 3, at least one of the first distance in the second direction between the first reflective portion 21 and the antenna element 12, or the second distance in the second direction between the second reflective portion 22 and the antenna element 12 is one third or less of the wavelength of the radio waves.

The “first distance” corresponds to the “distance DX1” in an aspect described above. The “second distance” corresponds to the “distance DX2” in an aspect described above.

According to an aspect described above, it is possible to further suppress the deterioration of the directivity of the antenna caused by the radio wave scattering.

### (Aspect 4)

In an aspect 4, at least one of the first distance or the second distance is one tenth or more and one fifth or less of the wavelength of the radio waves.

According to an aspect described above, it is possible to further suppress the deterioration of the directivity of the antenna caused by the radio wave scattering.

### (Aspect 5)

In an aspect 5, the reflective element 20 includes the third reflective portion 23 located between the structural portion 2 and the antenna element 12 in the first direction.

According to an aspect described above, it is possible to further suppress the deterioration of the directivity of the antenna caused by the radio wave scattering.

### (Aspect 6)

In an aspect 6, the third distance in the first direction between the third reflective portion 23 and the antenna element 12 is one tenth or more of the wavelength of the radio waves.

The “third distance” corresponds to the “distance DY” in an aspect described above.

According to an aspect described above, it is possible to further suppress the deterioration of the directivity of the antenna caused by the radio wave scattering.

### (Aspect 7)

In an aspect 7, when the reflective element 20 is viewed in a direction perpendicular to the first direction and the second direction, the first reflective portion 21, the second reflective portion 22, and the third reflective portion 23 have a connected shape.

According to an aspect described above, it is possible to further suppress the deterioration of the directivity of the antenna caused by the radio wave scattering.

### (Aspect 8)

In an aspect 8, the radio waves are linearly polarized waves, and the first reflective portion 21, the second reflective portion 22, and the third reflective portion 23 include a plurality of linear portions 24 configured to reflect the linearly polarized waves.

According to an aspect described above, it is possible to further suppress the deterioration of the directivity of the antenna caused by the radio wave scattering.

### (Aspect 9)

In an aspect 9, the compensator 30 is comprised, the compensator 30 including the first amplifier 31 configured to amplify the radio waves that are transmitted, the second amplifier 32 configured to amplify the radio waves that are received, and a switch 33 configured to switch between a path having the first amplifier 31 and a path having the second amplifier 32, wherein the reflective element 20B is located between the compensator 30 and the antenna element 12B in the radiation direction of the radio waves.

According to an aspect described above, it is possible to suppress the influence of the radio waves of the antenna on the compensator 30.

### (Aspect 10)

In an aspect 10, the mobile body 1 is a vehicle including a device to check surroundings, and the antenna element 12 is disposed at the end portion of the device to check surroundings.

The “device to check surroundings” corresponds to the “side mirror 3” in an aspect described above.

According to an aspect described above, it is possible to expand the range of the directivity of the antenna 11.

### (Aspect 11)

In an aspect 11, the reflective element 20 is disposed at a location at which scattering of the radio waves by the structural portion 2 can be suppressed.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

### REFERENCE SIGNS LIST

1 mobile body (vehicle)
2 structural portion (vehicle body)
3 side mirror
10, 10A to 10K antenna device
12, 12A to 12K antenna element
20, 20B to 20K reflective element
21 first reflective portion
22 second reflective portion
23 third reflective portion
24 linear portion
30 compensator
31 first amplifier
32 second amplifier
33 switch

1. An antenna device disposed at a mobile body that includes a structural portion, the antenna device comprising:
an antenna element disposed apart from the structural portion, the antenna element supporting radio waves in a predetermined frequency band; and
a reflective element configured to reflect the radio waves, the reflective element being located between the structural portion and the antenna element in a radiation direction of the radio waves.

2. The antenna device according to claim 1, wherein
the reflective element includes a first reflective portion and a second reflective portion,
a first direction is a direction in which the antenna element is separated from the structural portion, and
the antenna element is located between the first reflective portion and the second reflective portion in a second direction perpendicular to the first direction.

3. The antenna device according to claim 2, wherein at least one of a first distance in the second direction between the first reflective portion and the antenna element or a second distance in the second direction between the second reflective portion and the antenna element is one third or less of a wavelength of the radio waves.

4. The antenna device according to claim 3, wherein at least one of the first distance or the second distance is one tenth or more and one fifth or less of the wavelength of the radio waves.

5. The antenna device according to claim 2, wherein the reflective element includes a third reflective portion located between the structural portion and the antenna element in the first direction.

6. The antenna device according to claim 5, wherein a third distance in the first direction between the third reflective portion and the antenna element is one tenth or more of the wavelength of the radio waves.

7. The antenna device according to claim 5, wherein when the reflective element is viewed in a direction perpendicular to the first direction and the second direction, the first reflective portion, the second reflective portion, and the third reflective portion have a connected shape.

8. The antenna device according to claim 5, wherein
the radio waves are linearly polarized waves, and
the first reflective portion, the second reflective portion, and the third reflective portion include a plurality of linear portions configured to reflect the linearly polarized waves.

9. The antenna device according to claim 1 further comprising:
a compensator including
a first amplifier configured to amplify the radio waves that are transmitted,
a second amplifier configured to amplify the radio waves that are received, and
a switch configured to switch between a path having the first amplifier and a path having the second amplifier, wherein
the reflective element is located between the compensator and the antenna element in the radiation direction of the radio waves.

10. The antenna device according to claim 1, wherein
the mobile body is a vehicle including a device to check surroundings, and
the antenna element is disposed at an end portion of the device to check surroundings.

11. The antenna device according to claim 1, wherein
the reflective element is disposed at a location at which scattering of the radio waves by the structural portion can be suppressed.
